(19) United States
(12) Patent Application Publication
(10) Pub. No.: US 2025/0018327 A1
(43) Pub. Date: Jan. 16, 2025

(54) CO2 CAPTURE AND DESORPTION USING CORE-SHELL CATALYSTS

(71) Applicant: The University of Melbourne, Victoria (AU)

(72) Inventors: Masood SHEIKH ALIVAND, Victoria (AU); Kathryn Anne MUMFORD, Victoria (AU); Geoffrey Wayne STEVENS, Victoria (AU); Yue WU, Victoria (AU)

(21) Appl. No.: 18/711,218

(22) PCT Filed: Nov. 18, 2022
(86) PCT No.: PCT/AU2022/051381

§ 371 Date: May 17, 2024

(30) Foreign Application Priority Data
Nov. 19, 2021 (AU) 2021903737

(51) Int. Cl. B01D 53/14; B01D 53/62; B01D 53/96; B01J 23/745; B01J 31/04; B01J 31/16; B01J 35/23; B01J 35/40; B01J 37/03; B01J 37/06; B01J 37/34

(52) U.S. Cl. CPC B01D 53/1425; B01D 53/1475; B01D 53/62; B01D 53/96; B01J 23/745; B01J 31/04; B01J 31/1691; B01J 35/23; B01J 35/40; B01J 37/031; B01J 37/06; B01J 37/343; B01D 2252/20405; B01D 2252/20421; B01D 2252/20484; B01D 2252/602; B01D 2257/504; B01D 2258/0283

(57) ABSTRACT

A method of desorbing CO₂ from an aqueous liquid comprising CO₂, the method comprising the steps of: a) providing said aqueous liquid in the form of an aqueous colloidal solution comprising (i) a CO₂ absorbent having CO₂ absorbed thereto and (ii) colloidal catalyst having a core-shell structure in which the shell comprises proton-donor groups, and b) thermally desorbing CO₂ from the CO₂ absorbent, wherein the thermal desorption of the CO₂ is catalysed by the colloidal catalyst.

### FIELD OF THE INVENTION

The invention relates generally to carbon capture and storage (CCS) technologies, and more specifically to a method of desorbing CO₂ from an aqueous liquid comprising CO₂.

### BACKGROUND OF THE INVENTION

CO₂ emissions from industrial processes and their adverse implications on the climate is of major concern. The development of technologies for carbon capture and storage (CCS) has been regarded as one of the most realistic pathways to curtail global warming and climate change. However, the energy-intensive nature of CO₂ capture and therefore its expensive cost of operation has been regarded as the main barrier halting its widespread implementation among the low carbon energy technologies currently available.

There are a number of available CO₂ separation and purification technologies, mostly involving absorption, adsorption, membrane separation, and cryogenic distillation. Of those, chemical absorption-desorption using aqueous solvents (in the form of aqueous solutions of a CO₂-absorbent) has been the most reliable and therefore promising one for large-scale post-combustion CO₂ capture (PCC). Nevertheless, aqueous solvent-based absorption-desorption is not inherently a green technology. The high energy demand for solvent regeneration indirectly contributes to the global CO₂ emission. Additionally, the inherent energy-intensive nature of existing absorption-desorption procedures, which is mainly attributed to the high solvent regeneration temperature, can strongly impact the economics of the process. Further, slow desorption kinetics negatively affect the overall efficiency of the process and are intrinsically linked with the process's excessive energy requirements.

An available strategy to reduce the intensive regeneration energy involves the use of phase-change solvents. Those solvents are non-aqueous or aqueous-based solutions of amines, amino acids, or ionic liquids that can form two immiscible CO₂-rich and CO₂-lean phases after CO₂ absorption. The significant difference in the concentration of absorbed CO₂ in the two phases drives the CO₂ transfer between a CO₂-rich phase and a CO₂-lean phase. There are nevertheless a number of operational issues with this technology, which are mainly related to the marked tendency of those solvent to split into liquid-liquid and liquid-solid phases, thereby limiting their large-scale implementation.

More recently, heterogeneous catalytic CO₂ desorption for aqueous solvent regeneration has drawn significant attention in CCS technologies with discrete potential for large-scale implementation. A series of catalysts functioning as desorption rate promoters have been successfully developed, including metal compounds (e.g. Zn(II) compounds), metal oxides, zeolites, and mesoporous silica materials. However, the efficiency of existing heterogeneous catalytic systems is limited by the inherent instability of those catalysts in the aqueous reaction media. While this may be obviated to some extent by providing the catalysts on an external support, this inevitably requires the implementation of additional infrastructure into existing separation plants. This leads to significantly higher operation costs and hinder the large-scale applicability of conventional heterogeneous catalytic CO₂ desorption technologies.

There remains therefore an opportunity to develop alternative technologies for effective CO₂ desorption for aqueous solvent regeneration.

### SUMMARY OF THE INVENTION

The present invention provides a method of desorbing CO₂ from an aqueous liquid comprising CO₂, the method comprising the steps of: a) providing said aqueous liquid in the form of an aqueous colloidal solution comprising (i) a CO₂ absorbent having CO₂ absorbed thereto and (ii) colloidal catalyst having a core-shell structure in which the shell comprises proton-donor groups, and b) thermally desorbing CO₂ from the CO₂ absorbent, wherein the thermal desorption of the CO₂ is catalysed by the colloidal catalyst.

By having a core-shell structure in which the shell comprises proton-donor groups, the colloidal catalyst of the invention can carry a significantly higher amount of proton-donor groups relative to conventional heterogeneous catalysts or catalysts having corresponding groups attached directly to the surface of a core material. This can afford a number of technical advantages over conventional catalytic systems.

Due to the marked ability of proton-donor groups to provide stable hydrogen bonds with water molecules, the colloidal catalyst used in the method of the invention is extremely water-dispersible. The colloidal catalyst can therefore form stable colloidal solutions in aqueous media, and therefore does not require external means (e.g. mechanical agitation) to remain suspended. This can eliminate the need for dedicated external supports for the catalyst (e.g. bed reactors etc.).

In addition, catalytic activity towards CO₂ desorption from the CO₂-absorbent is believed to be linked to the proton-donor ability of the catalyst. In conventional heterogeneous catalysts, proton-donor groups are either inherent to the catalyst atomic structure (e.g. in the form of atomic defects) or provided as surface functional groups. The ability to provide high density of proton-donor groups in those heterogeneous catalysts is therefore limited. In contrast, by providing a higher density of proton-donor groups, the colloidal catalyst of the invention can display higher catalytic activity relative to conventional heterogeneous catalysts. This advantageously results in an enhancement of the desorption efficiency, acceleration of CO₂ desorption rate, decrease of CO₂ stripping time, and decrease of total desorption energy relative to existing catalytic systems for a given set of operational desorption parameters.

Advantageously, the method of the invention affords a more energy-efficient catalytic desorption of CO₂ than that offered by conventional heterogeneous catalysts, providing enhanced CO₂ desorption at lower operating temperatures with reduced energy consumption. This is believed to be due to a synergic combination of physical (i.e. Brownian motion associated with the colloidal catalyst dispersed in the aqueous medium) and chemical (i.e. proton-donation ability) effects. As a net result, the method of the invention affords thermal desorption of CO₂ from the CO₂-absorbent at a temperature significantly lower relative to non-catalytic processes or catalytic desorption processes based on conventional heterogeneous catalysts. For example, the method of the invention affords thermal CO₂ desorption at a temperature below the boiling point of water at a given pressure (for instance below 100° C. for desorption at atmospheric pressure).

In some embodiments, the provision of the aqueous liquid in the method of the invention comprises contacting a CO₂-containing fluid with an aqueous colloidal solution of the CO₂ absorbent and the colloidal catalyst. The method can therefore be implemented during operation of industrial CO₂ absorption-desorption cycles for the CO₂ extraction from a CO₂-containing fluid.

The CO₂-containing fluid may be any fluid that comprises CO₂. Examples in that regard include flue gas, such as flue gas originated from industrial combustion processes. Other examples of CO₂-containing fluids suitable for use in the method of the invention include air, natural gas, process streams containing methane or ethane, or process streams generated during production of at least one of ammonia, cement, and fertilizer.

In some embodiments, thermal desorption of CO₂ from the CO₂ absorbent is promoted by heating the aqueous colloidal solution. This can be particularly advantageous in the context of continuous large-scale CO₂ sequestration plants, where the method of the invention can afford significant savings on operational costs. For instance, by enabling thermal CO₂ desorption at significantly low temperatures, the method of the invention can be efficiently performed utilizing low grade heat resources, such as solar hot water, as a greener approach for aqueous solvent regeneration relative to existing regeneration processes. As such, the method of the invention can drastically reduce the energy requirements of post-combustion CO₂ capture technologies, solvent regeneration procedures, and abatement of CO₂ emissions from cement kilns, iron and steel manufacturing, ammonia, and fertilizer production.

In some embodiments, the aqueous liquid in the method of the invention is obtained by dispersing the colloidal catalyst into an aqueous solution of CO₂ absorbent having CO₂ absorbed thereto. In those instances, the method of the invention can be implemented for the ad-hoc regeneration of spent CO₂ absorbent solutions isolated form existing separation plants. In addition, heating said aqueous solution of CO₂ absorbent having CO₂ absorbed thereto before dispersing the colloidal catalyst offers an additional avenue for thermal CO₂ desorption, for example when the aqueous solution is heated to a temperature conducive to catalytic CO₂ desorption. In that case, the subsequent dispersion of the colloidal catalyst can trigger thermal CO₂ desorption.

Accordingly, in some embodiments thermal desorption of CO₂ from the CO₂ absorbent is promoted by heating said aqueous solution comprising the CO₂ absorbent having CO₂ absorbed thereto, and introducing thereto the colloidal catalyst.

The method of the invention can be directly implemented as the regeneration step of a continuous industrial absorption/desorption process for large-scale CO₂ sequestration. In addition, protons released by the colloidal catalyst when catalysing CO₂ desorption can effectively be recovered during subsequent CO₂ absorption process, making the aqueous solution of the invention highly suitable for use in cyclic CO₂ absorption-desorption plants. This is in contrast to conventional heterogeneous solid acid catalysts, which require to be regenerated (i.e. protonated) by acid washing.

### BRIEF DESCRIPTION OF THE DRAWINGS

Embodiments of the invention will be now described with reference to the following non-limiting drawings, in which:

FIG. 1 shows zeta potential values of colloidal catalysts having a Fe₃O₄ core and an amino acid shell, measured by dispersing 0.1M colloidal catalysts in 3-(N-morpholino) propanesulfonic acid (MOPS) buffer at pH 9.0,

FIG. 2 shows a schematic diagram of a large-scale cyclic CO₂ absorption-desorption process plant, particularly designed for a compatible operation using solar hot water as the main thermal source for low-temperature CO₂ desorption for regeneration of spent CO₂-absorbent solution,

FIG. 3 shows (a) CO₂ desorption enhancement (relative to non-catalysed desorption) of a spent 5M MEA aqueous colloidal solution catalysed by Fe₃O₄-Ala core-shell colloidal catalyst (benchmark) and Fe₃O₄-Ala core-shell catalyst further functionalised with increasing amounts of sulfanilic acid groups (A-D), (b) CO₂ desorption temperature profiles of spent 5M MEA aqueous solution without (blank) and in the presence of Fe₃O₄-Ala-C colloidal catalyst; and (c) CO₂ desorption enhancement (relative to non-catalysed desorption) obtained using Fe₃O₄-Ala-C core-shell colloidal catalyst on a spent 5M MEA aqueous colloidal solution,

FIG. 4 shows (a) the total amount of desorbed CO₂ at different time intervals during the catalytic regeneration of a spent 5M MEA aqueous colloidal solution using Fe₃O₄-Ala-C colloidal catalyst; (b) relative heat duty required to regenerate a spent 5M MEA aqueous solution using conventional Al₂O₃ metal oxide and HZSM-5 zeolite heterogeneous catalysts, relative to Fe₃O₄-Ala-C colloidal catalyst; and (c) catalytic performance of Fe₃O₄-Ala-C colloidal catalyst during consecutive CO₂ absorption-desorption cycles. The concentration of catalyst in the aqueous spent solution is 0.1 wt. % in all tests,

FIG. 5 shows (a) the relative heat duty of different aqueous colloidal solutions of amino acid CO₂-absorbents (1M in water) and Fe₃O₄-Ala-C colloidal catalyst (i.e. Fe₃O₄ core with Ala amino acid shell further functionalised with sulfanilic acid groups), relative to their corresponding heat duties in the absence of the colloidal catalyst; and (b) CO₂ desorption profile (top) and relative heat duty (bottom) of primary (MEA, 5M), tertiary (MDEA, 2M) and primary-tertiary (MEA-MDEA, 5M-2M) amine aqueous solutions with and without using Fe₃O₄-Ala-C colloidal catalyst. The relative heat duties for all amines are calculated in a comparison with 5M MEA aqueous solution without using colloidal catalyst. The concentration of colloidal catalyst was kept constant at 0.1 wt. % in all tests,

FIG. 6 shows (a) schematic of thermal CO₂ desorption from a spent amine aqueous solution with and without using a colloidal catalyst in accordance to embodiments of the invention; (b) CO₂ desorption profile during thermal regeneration of a spent amine aqueous solution using different concentrations of Fe₃O₄—COOH colloidal catalyst; (c) relative heat duty (RH) and (d) cyclic CO₂ uptake capacity of a CO₂-absorbent amine aqueous colloidal solution containing various colloidal catalysts in accordance to embodiments of the invention,

FIG. 7 shows (a) a schematic of catalytic CO₂ desorption during thermal CO₂ desorption; (b) the effect of time on the accumulative desorbed CO₂ with and without using a Fe₃O₄@UIO-66-SO₄ colloidal catalyst; and (c) relative heat duty (RH) of cyclic regeneration of a spent amine solution in the absence of a catalyst (blank) and in the presence of conventional commercial heterogeneous catalysts (Al₂O₃, V₂O₅, H-Beta, HZSM-5) or Fe₃O₄—COOH and Fe₃O₄@UIO-66-SO₄ colloidal catalysts (0.1 wt. %) in accordance to embodiments of the invention,

FIG. 8 shows (a) a schematic of cyclic CO₂ absorption-desorption using colloidal catalyst-aided spent solvent regeneration; (b) the effect of colloidal catalyst concentration on the cyclic CO₂ capacity of the CO₂-absorbent aqueous solution using no catalyst (blank (A)), with H-Bata conventional catalyst (B), Fe₃O₄—COOH colloidal catalyst (C), Fe₃O₄@UIO-66 colloidal catalyst (D), and Fe₃O₄@UIO-66-SO₄ colloidal catalyst (E); and (c) recyclability of Fe₃O₄@UiO-66-SO₄ colloidal catalyst during consecutive CO₂ absorption-desorption cycles. The CO₂-absorbent in all tests was MEA (5M in water), and the concentration of colloidal catalyst was 0.1 wt. % during all tests,

FIG. 9 shows the zeta potential of monodispersed carbon spheres (MCSs) prepared with various amounts of Na₃Cit as a structure-directing agent,

FIG. 10 shows (a) CO₂ desorption enhancement achieved at 98° C. after adding MCS-SO₃H colloidal catalyst to various CO₂-saturated amino acid solutions (1 M), and (b) CO₂ desorption profile of 1 M LysK solution (A) with 0.2 wt. % MCS-SO₃H and (B) without MCS-SO₃H colloidal catalyst,

FIG. 11 shows (a) the accumulated excess amount of CO₂ released at different time intervals as the direct effect of MCS-SO₃H colloidal catalyst in CO₂-saturated amino acid solutions (1 M), and (b) the amount of desorbed CO₂ with and without using MCS-SO₃H colloidal catalyst at different regeneration temperatures,

FIG. 12 shows (a) the effect of MCS-SO₃H concentration on CO₂ desorption enhancement, (b) CO₂ desorption enhancement achieved for MCS-SO₃H and PF-MCS-SO₃H colloidal catalysts, and (c) enhancement factor (i.e. the enhancement per catalyst concentration in the solution) of different heterogeneous (i.e. Montmorillonite (A), SO₄²⁻/ZrO₂/Al₂O₃(B) and SO₄²⁻—/ZrO₂/SBA-15 (C)) and water-dispersible (i.e. MCS-SO₃H (D)) colloidal catalysts. The catalyst concentration was kept constant at 1 and 0.2 wt % for heterogeneous and water-dispersible colloidal catalyst, and

FIG. 13 shows recyclability data of MCS-SO₃H catalysts (0.2 wt. %) over consecutive direct air capture (DAC) cycles, using an amino acid solution (1M LysK) and a solvent regeneration constant temperature of 98° C. The solution was saturated with air with ˜410 ppm CO₂.

### DETAILED DESCRIPTION OF THE INVENTION

The present invention is directed to a method of desorbing CO₂ from an aqueous liquid comprising CO₂.

The CO₂ may be absorbed CO₂ that is naturally present in atmospheric air or derived by any process involving release of CO₂. For instance, the CO₂ may be produced during burning of hydrocarbon fuels (such as wood, coal, natural gas, gasoline, and oil), or by other industrial processes such as cement manufacturing (e.g. from cement kilns), metal manufacturing (e.g. iron and steel), ammonia, and fertilizer production.

In the method of the invention, the aqueous liquid is provided in the form of an aqueous colloidal solution comprising a CO₂ absorbent having CO₂ absorbed thereto. For the purpose of the invention, absorption of CO₂ to the CO₂-absorbent may be effected by any means known to the skilled person. In that regard, there exist numerous established technologies and processes for the absorption of CO₂ using aqueous solutions of one or more CO₂ absorbent(s).

CO₂ may be present in the aqueous liquid in accordance to any amount that can be absorbed by the CO₂-absorbent. For example, the aqueous liquid may comprise an amount of CO₂ (absorbed on the CO₂-absorbent) of at least about 0.01 mol-CO₂/mol-absorbent. In some embodiments, the aqueous liquid comprise an amount of CO₂ (absorbed on the CO₂-absorbent) of at least about 0.02 mol-CO₂/mol-absorbent, at least about 0.05 mol-CO₂/mol-absorbent, at least about 0.1 mol-CO₂/mol-absorbent, at least about 0.2 mol-CO₂/mol-absorbent, at least about 0.5 mol-CO₂/mol-absorbent, at least about 0.9 mol-CO₂/mol-absorbent, at least about 1 mol-CO₂/mol-absorbent, at least about 2 mol-CO₂/mol-absorbent, at least about 5 mol-CO₂/mol-absorbent, or at least about 10 mol-CO₂/mol-absorbent. In some embodiments, the aqueous liquid comprises an amount of CO₂ (absorbed on the CO₂-absorbent) of from about 0.15 mol-CO₂/mol-absorbent to at least about 0.9 mol-CO₂/mol-absorbent.

For the purpose of the invention, any CO₂-absorbent that can be provided in an aqueous solution and which is effective to absorb CO₂ may be used. In some embodiments, the CO₂ absorbent is selected from an amine, an amino acid, an ionic liquid, a carbonate, a base, and a mixture thereof.

In some embodiments, the CO₂ absorbent is an amine. The amine may be a primary amine, a secondary amine, a tertiary amine, or a mixture thereof. Examples of suitable amines in that regard include monoethanolamine (MEA), diglycolamine (DGA), diethanolamine (DEA), di-isopropanolamine (DIPA), triethanolamine (TEA), methyldiethanolamine (MDEA), 2-Amino-2-methylpropanol (AMP), benzylamine (BZA), piperazine (PZ), N,N-Diethyl-1,3-diaminopropane (DEAPA), beta-Diethylaminoethyl alcohol (DEEA), 1-Dimethylamino-2-propanol (1DMA2P), and 4-(diethylamine)-2-butanol (DEAB). Any of those amines may be used on its own or in combination with any one or more other amine(s). In some embodiments, the CO₂-absorbent is monoethanolamine (MEA).

In some embodiments, the CO₂ absorbent is a base. Example of suitable bases include calcium hydroxide, soda lime, sodium hydroxide, potassium hydroxide, and lithium hydroxide.

In some embodiments, the CO₂-absorbent is an amino acid. For instance, the CO₂-absorbent may be a long-chain amino acid (i.e. arginine and lysine), a short-chain amino acid (i.e. glycine and sarcosine), a cyclic amino acid (i.e. histidine), or a combination thereof. For example, the CO₂-absorbent may be an amino acid of the kind described herein.

The aqueous liquid of the invention may comprise any amount of CO₂-absorbent conducive to CO₂ absorption. In some embodiments, the aqueous liquid comprises the CO₂ absorbent in a concentration of at least about 0.1M, at least about 0.5M, at least about 1M, at least about 5M, or at least about 10M. For example, the aqueous liquid may comprise the CO₂ absorbent in a concentration of about 5M.

In the method of the invention, the aqueous liquid is provided in the form of an aqueous colloidal solution that comprises colloidal catalyst in addition to the CO₂-absorbant.

Presence of said colloidal catalyst provides for the aqueous liquid to be an aqueous colloidal solution. By the aqueous solution being “colloidal” (or a “colloid” or “hydrocolloid”) is meant that the solution is a mixture of insoluble particulate material dispersed in the aqueous medium to form a stable suspension. Unlike a conventional liquid solution, in which solute and solvent constitute a single phase, the aqueous colloidal solution of the invention is made of a dispersed phase (i.e. insoluble particulate material) and a continuous phase (i.e. the aqueous medium). While the physical state of the dispersed phase (i.e. solid) differs from that of the aqueous medium (i.e. liquid), the aqueous colloidal solution of the invention can effectively be regarded as a “homogeneous” mixture, in that the dispersed phase does not settle. This is in direct opposition to, for example, conventional heterogeneous aqueous suspensions of particulate material that settles unless it is kept in suspension by mechanical means (e.g. mechanical agitation).

By the catalyst used in the method of the invention being “colloidal” is therefore meant that the catalyst is provided in the form of particulate material that forms a stable colloidal suspension when dispersed in an aqueous medium. Typically, the colloidal catalyst of the invention would be understood to be particulate material made of particles which larger dimension ranges between about 0.1 nm and about 1,000 nm.

In some embodiments, the colloidal catalyst has a largest dimension of between about 1 nm and about 1,000 nm, between about 5 nm and about 900 nm, between about 10 nm and about 750 nm, between about 10 nm and about 500 nm, or between about 100 nm and about 500 nm.

In the method of the invention, the provision of the aqueous liquid in step a) may comprise dispersing the colloidal catalyst into an aqueous solution of CO₂-absorbent having CO₂ absorbed thereto. In those instances, the method of the invention is useful for the ad-hoc regeneration of spent CO₂-absorbent aqueous solutions (i.e. solutions in which at least a fraction of CO₂-absorbent has CO₂ absorbed thereto). Such spent solutions may be, for example, solutions that are obtained following conventional CO₂ liquid-absorption and regenerated separately from the main absorption plan (i.e. in a non-continuous process).

In some embodiments, the provision of the aqueous liquid in the method of the invention comprises contacting a CO₂-containing fluid with an aqueous colloidal solution of the CO₂ absorbent and the colloidal catalyst. These instances would be common in the context of industrial CO₂ absorption-desorption cycles for the continuous CO₂ extraction from a CO₂-containing fluid.

In some embodiments, said CO₂-containing fluid is flue gas, air, natural gas, a process stream containing methane or ethane, or a process stream generated during production of at least one of ammonia, cement, and fertilizer. In those instances, the method of the invention can find direct implementation as the regeneration step of a continuous industrial absorption/desorption process for large-scale CO₂ sequestration. In some embodiments, said CO₂-containing fluid is flue gas, such as flue gas originated from industrial combustion processes.

The aqueous colloidal solution provided in the method of the invention may comprise any amount of colloidal catalyst conducive to the solution being a stable aqueous colloidal solution. In some embodiments, the aqueous colloidal solution comprises about 10 wt. % or less, about 5 wt. % or less, about 1 wt. % or less, about 0.5 wt. % or less, about 0.1 wt. % or less, about 0.05 wt. % or less, or about 0.01 wt. % or less of the colloidal catalyst.

In some embodiments, the aqueous colloidal solution comprises about 0.1 wt. % or less of the colloidal catalyst. That concentration range represents an advantageous balance between physical catalysis deriving from the Brownian motion of the colloidal catalyst in the aqueous colloidal solution and the chemical catalysis deriving from the marked catalytic activity of the colloidal catalyst. For instance, an amount of colloidal catalyst in the aqueous colloidal solution of between about 0.075 and about 0.125 wt. %, for example about 0.1 wt. %, was found to provide a particularly energy-efficient catalytic desorption of CO₂ from the CO₂-absorbent. Said concentration range of the colloidal catalyst was observed to deliver catalytic CO₂ desorption kinetics characterised by high energy efficiency parameter (defined by the absolute of relative heat duty reduction versus the amount of catalyst used). Without wanting to be confined by theory, this is believed to be linked to the particularly advantageous level of Brownian motion reached by the colloidal catalyst at that concentration, for a given desorption temperature.

The colloidal catalyst used in the method of the invention will be characterised by a negative surface zeta potential which makes it suitable to form a stable aqueous colloidal solution. For example, the colloidal catalyst may be characterised by a negative surface zeta potential (at 25° C. and pH 9) of about −10 mV or less.

In some embodiments, the colloidal catalyst is characterised by a negative surface zeta potential (at 25° C. and pH 9) of about −15 mV or less, about −20 mV or less, about −30 mV or less, about −35 mV or less, about −40 mV or less, about −45 mV or less, or about-50 mV or less, measured at about 25° C. and in water at pH 9. In some embodiments, the colloidal catalyst is characterised by a negative surface zeta potential of about-30 mV or less (at 25° C. and pH 9). In some embodiments, the colloidal catalyst is characterised by a negative surface zeta potential of about −40 mV or less (at 25° C. and pH 9).

The colloidal catalyst used in the method of the invention has a core-shell structure. By the structure of the colloidal catalyst being “core-shell” is meant that the colloidal catalyst is made of a core material which is either wholly covered or otherwise surrounded by an outer shell layer made of another material. The provision of a shell offers significant advantages in terms of tailoring the chemical characteristics of the colloidal catalyst surface.

The shell of the colloidal catalyst comprises proton-donor groups. By the expression “proton-donor group” is meant herein any chemical group that can donate protons in an acid-base reduction reaction in an aqueous medium. As such, that expression in the context of the present invention will be taken in accordance to its broadest meaning to encompass specific functional groups showing proton-donor activity (e.g. —COOH functional groups), as well as structural defects of a compound that show proton-donor activity (e.g. ligand defects in the structure of a MOF).

Examples of proton-donor groups suitable for use in the colloidal catalyst of the invention include —PO₄, —SO₄, —SO₃H, —OH, —SH, —SO₂NH₂, —COOH, —PO₃H, —PO₃H₂, —PO₃H⁻M⁺, and a combination thereof. In the chemical formulas listed above, M⁺ is a metal cation.

In some embodiments, the proton-donor groups are chemical groups that display Brønsted acidity in aqueous medium.

In some embodiments, the proton-donor groups comprise superacid groups. As used herein, the term “superacid” (and corresponding terms such as “superacidity”) means acids stronger than 100% sulfuric acid, that is acids with a Hammett acidity function H₀≤−12. Advantageously, superacid groups (such as —SO₄) are characterised by advanced proton donation capability, leading to accelerated CO₂ desorption performance.

The core of the colloidal catalyst may be made of any material that can be provided with an outer shell of the kind described herein.

In some embodiments, the colloidal catalyst has a core selected from a metal oxide, a liquid metal, a polymer, a carbon-based material (e.g., graphene, graphene oxide, graphene quantum dot, CNT and MWCNT), a nitride (e.g. carbon nitride, boron nitride), a metal-phenolic network (MPN), and a metal-organic framework (MOF).

In some embodiments, the colloidal catalyst has a metal oxide core. Suitable examples of metal oxides for use in the core of the colloidal catalyst include Fe₃O₄, Al₂O₃, V₂O₅, ZrO₂, NiO, CuO, ZnO, ZrO₂, Ag₂O, MnO₂, Nb₂O₅, Cr₂O₃, TiO₂, WO₃, MoO₃, and any combination thereof. In some embodiments, the colloidal catalyst has a Fe₃O₄ core.

In some embodiments, the colloidal catalyst has a liquid metal core. Examples of liquid metals suitable for use in those instances include liquid tin and liquid gallium.

In some embodiments, the colloidal catalyst has a polymer core. Examples of suitable polymers that may be used as the colloidal catalyst core include functionalized poly(acrylic acid), poly(methyl methacrylate), polystyrene, or a bled thereof.

In some embodiments, the colloidal catalyst has a carbon-based core. Example of carbon-base materials suitable for use in those instances include carbon, graphene, graphene oxide, graphene quantum dot, carbon nanotubes (CNT), either single- or multi-walled carbon nanotubes (MWCNT). In some embodiments, the colloidal catalyst has a carbon core, for example in the form of a carbon particle (also referred herein as “carbon sphere” when said carbon particles has spherical morphology).

In some embodiments, the colloidal catalyst has a metal-phenolic network (MPN) core. As they are known in the art, MPNs are supramolecular coordination structures made of metal ions coordinated by acidic phenols and/or polyphenols.

In some embodiments, the colloidal catalyst has a metal-organic framework (MOF) core. As they are known in the art, MOFs are hybrid coordination structures formed by metal clusters comprising metal ions (e.g. metal ions or metal oxides) coordinated by multi-functional organic ligands. As used herein, the expression “metal cluster” means a chemical moiety that contains at least one atom or ion of at least one metal or metalloid. This definition embraces single atoms or ions and groups of atoms or ions that optionally include organic ligands or covalently bonded groups. Accordingly, the expression “metal ion” includes, for example, metal ions, metalloid ions and metal oxides.

Suitable metal ions that form part of a MOF structure can be selected from Group 1 through 16 metals of the IUPAC Periodic Table of the Elements including actinides, and lanthanides, and combinations thereof. For example, the metal ion may be selected from Zr⁴⁺, Cr⁶⁺, Cr³⁺, Mo⁶⁺, Fe³⁺, Fe²⁺, Cu²⁺, Cu²⁺, Zn²⁺, and a combination thereof.

Suitable metal ion coordinating organic ligands can be derived from oxalic acid, malonic acid, succinic acid, glutaric acid, phtalic acid, isophtalic acid, terephthalic acid, citric acid, trimesic acid, 1,2,3-triazole, pyrrodiazole, or squaric acid. Organic ligands suitable for the purpose of the invention comprise organic ligands listed in WO 2010/075610 and Filipe A. Almeida Paz, Jacek Klinowski, Sergio M. F. Vilela, João P. C. Tomé, José A. S. Cavaleiro, João Rocha, ‘Ligand design for functional metal-organic frameworks’, Chemical Society Reviews, 2012, Volume 41, pages 1088-1110, the contents of which are included herein in their entirety.

In some embodiments, the MOF is a Zr-based MOF. Examples of Zr-based MOFs that can be used in the invention include MOFs of the UiO-66 or UiO-67 type. A detailed characterisation of these MOFs and description of their synthesis is reported in J. H. Cavka et al., Journal of the American Chemical Society, 2008, 130, 13850, the content of which is incorporated herein in its entirety.

In some embodiments, the MOF is a zinc imidazolate framework (ZIF). ZIF frameworks feature tetrahedrally-coordinated transition metal ions (e.g. Fe, Co, Cu, Zn) connected by organic imidazolate organic ligands, resulting in three-dimensional porous solids. Similarly to zeolites, ZIFs have great thermal and chemical stability.

In some embodiments, the MOF is an aluminium-based MOF. Examples of aluminium-based MOFs include MIL-100 (Al) and CAU-10. CAU-10 is made up of helical chains of cis-connected, corner sharing A106-polyhedra linked by the V-shaped 1,3-benzene dicarboxylic acid or isophtalic acid. Examples of aluminium-based MOFs and their respective synthesis is are described in Reinsch, Stock, et al., Chemistry of Materials, 2013, 25, 17, the content of which is incorporated herein in its entirety.

Accordingly, the MOF that may be made in accordance with the invention may be a carboxylate-based MOF, a heterocyclic azolate-based MOF, or a metal-cyanide MOF. Specific examples of MOFs that may be made according to the present invention include UiO-66, UiO-66-NH₂, ZIF-8, ZIF-67, MIL-100 (Fe), MIL-101 (Cr), MOF-Fe(II), HKUST-1, and a combination thereof.

The shell of the colloidal catalyst may be made of any material that comprises proton-donor groups, for example proton-donor groups of the kind described herein. For instance, said groups may be either inherently present in the shell material in its native form (e.g. as atomic structural defects), or provided as functional groups attached to the shell material.

In some embodiments, the shell of the colloidal catalyst is selected from an amino acid shell, a liquid metal shell, a polymer shell, a carbon-based shell, a carbon nitride shell, a boron nitride shell, a metal-phenolic network (MPN) shell, a metal-organic framework (MOF) shell, or a combination thereof.

In some embodiments, the shell of the colloidal catalyst is an amino-acid shell. By inherently containing both amino (i.e. —NH₂) and proton-donor carboxyl (i.e. —COOH) functional groups, amino-acids afford high water dispersibility combined with abundant proton-donor acidic sites for catalytic CO₂ desorption. The chemical structure of amino-acids is also highly tuneable, offering numerous avenues for the customisation of their catalytic activity.

An amino acid shell is also advantageous when the core material is a metal oxide in which the metal can undergo oxidation/reduction transitions (e.g. Fe in Fe₃O₄, which can transition between Fe^{III} to Fe^{II}). In those instances, amino acids in aqueous medium can promote the partial reduction of the metal producing carboxylate-stabilized metal oxides. The assembly of carboxylates on the exterior surface of the metal oxide core (e.g. Fe₃O₄) also makes the colloidal catalyst a versatile platform for subsequent surface functionalization, thus affording surface enrichment with additional (and stronger) proton-donor groups (e.g. acidic sites such as —SO₃H). Accordingly, in some embodiments the colloidal catalyst of the invention has a Fe₃O₄ core and an aminoacid shell.

The amino acid for use in the shell of the colloidal catalyst may be any amino acid that can be provided as a shell in the colloid catalyst. Examples of suitable amino acids in that regard include Alanine (Ala), Serine (Ser) and Glycine (Gly), Proline (Pro), Valine (Val), Histidine (His), Lysine (Lys), Arginine (Arg), Glutamine (Glu), Sarcosine (Sarc), Leucine (Leuc), Asparagine (Asp), and a mixture thereof.

In some embodiments, the shell is a functionalised amino acid shell. For example, the amino acid may be functionalised with one or more proton donor groups of the kind described herein. In those instances, the catalytic activity of the colloidal catalyst can be further emphasised due to the cumulative proton-donor effect afforded by the additional functional groups. Accordingly, in some embodiments the shell of the colloidal catalyst is an amino acid shell functionalised with one or more group(s) selected from —PO₄, —SO₄, —SO₃H, —OH, —SH, —COOH, —PO₃H, —PO₃H₂. The superior proton-transfer ability of the resulting colloidal catalysts is due to the high density of acidic functional groups (including both the carboxylates from the amino acids and the added functional groups) as Brønsted acid sites.

In some embodiments, the shell of the colloidal catalyst is a liquid metal shell. Examples of liquid metals suitable for use in those instances include liquid tin and liquid gallium.

In some embodiments, the shell of the colloidal catalyst is a polymer shell. Examples of suitable polymers that may be used as the colloidal catalyst core include functionalized poly(acrylic acid), poly(methyl methacrylate), polystyrene, and any blend thereof. Proton-donor groups, for example proton-donor groups of the kind described herein, may be inherently present in the structure of the polymer and/or added to the polymer as functional groups.

For instance, a glucose precursor may be used in the synthesis of carbon spheres as core material for the colloidal catalyst. The synthesis may inherently result in formation of the carbon spheres surrounded by a shell of short-chain aromatic polymers deriving from incomplete carbonisation of the glucose precursor. These complex aromatic polymers can undergo subsequent functionalization with proton-donor groups, for example by addition of sulfate groups in the presence of sulfuric acid to form SO₃H-bearing carbon spheres.

In some embodiments, the shell of the colloidal catalyst is a carbon-based shell. Example of carbon-base materials suitable for use in those instances include graphene, graphene oxide, graphene quantum dot, carbon nanotubes (CNT), either single- or multi-walled carbon nanotubes (MWCNT). Proton-donor groups, for example proton-donor groups of the kind described herein, may be inherently present in the structure of the carbon-based material (for example in correspondence to intrinsic structural defects) and/or added to the carbon-based material as functional groups.

In some embodiments, the colloidal catalyst has a metal-phenolic network (MPN) shell. As they are known in the art, MPNs are supramolecular coordination structures made of metal ions (e.g. Zr ions) coordinated by acidic phenols and/or polyphenols. Proton-donor groups, for example proton-donor groups of the kind described herein, may be inherently present in the structure of the MPN (for example in correspondence to intrinsic structural defects) and/or added to the MPN as functional groups.

In some embodiments, the shell is a metal-organic framework (MOF) shell. The MOF may be a MOF of the kind described herein. In certain preferred embodiments, the shell is made of MOF selected from UiO-66, UiO-66-NH₂, ZIF-8, ZIF-67, MIL-100 (Fe), MIL-101 (Cr), MOF-Fe(II), HKUST-1, and a combination thereof.

It will be understood that the MOF shell of the colloidal catalyst will comprise proton-donor groups, which may be provided in the MOF in any form. For instance, such groups may be inherent to the chemical structure of the MOF (e.g. in correspondence to structural defects, such as unsaturated metal clusters), and/or may be provided as functional groups added to the MOF (for example functional groups of the kind described herein).

In some embodiments, the MOF is a MOF functionalised with proton-donor groups. Said groups may be provided by making the MOF using at least a portion of the organic ligands being functionalised organic ligands, for example functionalised with proton-donor groups of the kind described herein. For instance, any one of the organic ligands listed herein may be additionally characterised by the presence of amino-, such as 2-aminoterephthalic acid, urethane-, acetamide-, or amide-sulfonate-moieties. The organic ligand can be functionalised before being used as precursor for MOF formation or alternatively MOF can be chemically treated to functionalise its bridging ligands in a post-synthesis procedure. Alternatively, the proton-donor groups can be attached to unsaturated metal clusters present in the MOF chemical structure.

Examples of suitable proton-donor groups that may be provided on the MOF therefore include —PO₄, —SO₄, —SO₃H, —OH, —SH, —COOH, —PO₃H, —PO₃H₂, and —PO₃H M⁺. In the chemical formulas listed above, M⁺ is a metal cation.

In some embodiments, the MOF is functionalised with functional groups that display Brønsted acidity in aqueous medium. In some embodiments, the MOF is functionalised with superacid groups.

In some embodiments, the MOF shell is UiO-66-SO₄, UiO-66-PO₄, UiO-66-NH₂—SO₄, and HKUST-SO₄.

The use of shells of MOFs functionalised with proton-donor groups (e.g. a shell of UiO-66-SO₄, UiO-66-PO₄, etc.) is particularly advantageous, in that they are believed to promote unique catalytic CO₂ desorption mechanisms. Generally, and without wanting to be limited by theory, CO₂ molecules are released by carbamate breakdown reaction throughout CO₂ desorption. However, the yield of this reaction is highly dependent on the number of active protons in the reaction medium supplied by the CO₂-absorbent deprotonation reaction. Owing to the endothermic nature of all reactions, a high desorption temperature (˜120-140° C.) is typically required for spontaneous proton transfer and bond cleavage, resulting in high-quality steam use and subsequently high energy consumption. Without wanting to be limited by theory, it is believed that in functionalised MOFs (for example functionalised MOFs of the kind described herein), adsorbed water molecules on the surface of uncoordinated metal clusters can participate in a hydrogen bond with a proton-donor moiety chelated to another neighboring metal center in the MOF structure. This specific arrangement of proton-donors and water moieties results in the formation of strong Brønsted acid sites with distinct proton donation ability, accelerating the carbamate breakdown reaction and allowing for enhanced CO₂ desorption at low regeneration temperatures (less than 100° C.).

A skilled person would be aware of chemical protocols that would allow functionalising a MOF with suitable proton-donor groups, for example by pre-functionalising ligands used to synthesise the MOF, by functionalising bridging ligands of the MOF in a post-synthesis procedure, by adding said functions to uncoordinated sites of the MOF, or by a combination of those approaches.

The method of the invention requires thermally desorbing CO₂ from the CO₂ absorbent. This can be achieved by any means known to a skilled person, and requires bringing the CO₂ absorbent having CO₂ absorbed thereto to a temperature at which catalytic CO₂ desorption is promoted in the presence of the colloidal catalyst.

In some embodiments, the step of thermally desorbing the CO₂ from the CO₂ absorbent is promoted by heating the aqueous colloidal solution.

Alternatively, or in addition, the step of thermally desorbing the CO₂ from the CO₂ absorbent is promoted by heating an aqueous solution comprising the CO₂ absorbent having CO₂ absorbed thereto, and introducing thereto the colloidal catalyst.

Heating the relevant liquid (for example heating the aqueous colloidal solution and/or heating an aqueous solution comprising the CO₂ absorbent having CO₂ absorbed thereto prior to the introduction of the colloidal catalyst) may be effected by any means known to the skilled person. For instance, heating may be effected by use of a fuel heating system (e.g. oil or gas, etc.), an electrical heating system (e.g. coil heater, etc.), a hot fluid heating system (e.g. immersion heaters, tube heat exchangers, heating jackets, etc.), etc.

In some embodiments, heating is effected using heat generated by a solar heating system. For instance, the relevant liquid (e.g. the aqueous colloidal solution, or the aqueous solution comprising the CO₂ absorbent having CO₂ absorbed thereto) may be pumped through a solar collector, where it is directly heated.

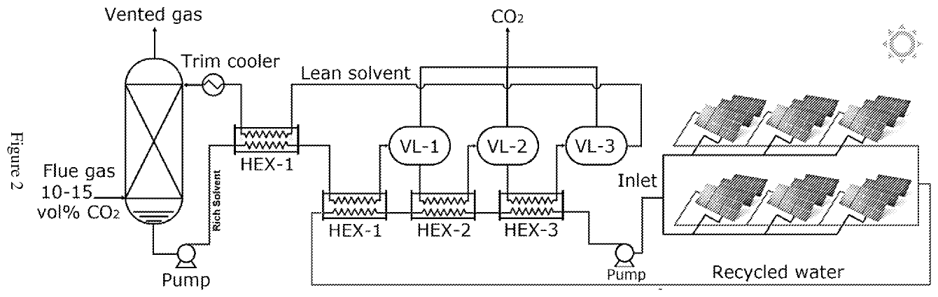

Alternatively, heat from a solar collector may be first transferred to a heat-transfer fluid, and the heat subsequently transferred to the relevant liquid to be heated using a heat exchanger. A schematic example of such a heating system is shown in FIG. 2. The schematic shows a hypothetical large-scale cyclic CO₂ absorption-desorption plant, particularly designed for a compatible operation based on the use of colloidal catalysts of the kind described herein combined with a solar hot-water circuit as the main source of heat for low-temperature CO₂ desorption in the regeneration step. The schematic allows to appreciate that a conventional desorption column which would be required for heterogeneous catalytic desorption in combination with a liquid-liquid heat exchanger can be omitted. Instead, a plurality of consecutive vapor-liquid separators (three in the schematic) that operate at different operating temperatures can be used, providing considerable savings in operational costs.

In a typical operation using the plant schematic of FIG. 2, hot water may be used as the main source of energy (for example a few degrees below boiling point, such as at about 90-98° C.). Said hot water can be readily provided from sustainable energy resources, particularly solar hot water. A constant temperature of about 10-20° C. can be assumed as the effective approach temperature for all liquid-liquid heat exchangers in the plant, increasing the aqueous colloidal solution temperature from about 30-40° C. in the absorption column (where CO₂ is absorbed by the CO₂-absorbent) to a maximum temperature of about 70-90° C. (e.g. about 88° C.) at the end of the liquid-liquid heating process. Therefore, a temperature of about 70-90° C. (e.g. about 88° C.) can be considered to be the maximum desorption (i.e. regeneration) temperature. Three vapor-liquid stages, rather than only using a single-stage, can be suggested to improve the heat transfer and, subsequently, CO₂ desorption efficiency.

In the context of the invention, it will be understood that thermally desorbing CO₂ from the CO₂ absorbent requires at least bringing the CO₂ absorbent to a temperature that is conducive to CO₂ desorbing from the CO₂-absorbent in the presence of the colloidal catalyst. Since thermal CO₂ desorption is catalysed by the colloidal catalyst, CO₂ desorbs at a temperature that is lower than that required to desorb CO₂ absent the colloidal catalyst (all other parameters being the same).

At constant temperature, the kinetics of CO₂ desorption from the CO₂ absorbent is much slower than that of the corresponding absorption. As such, high desorption temperatures are conventionally required for effective CO₂ desorption. This contributes to significant operational costs since heating in the absence of a catalyst or in the presence of conventional heterogeneous catalysts is typically performed at high temperatures (above 100° C.) to partially compensate for the lower CO₂ desorption rate. As such, conventional systems must be run using different temperatures for the absorption and separation steps, leading to high operation costs.

In the method of the invention, thermal CO₂ desorption is catalysed by the colloidal catalyst. By CO₂ desorption being “catalysed” by the colloidal catalyst is meant that at for a given heating temperature, CO₂ desorption rate is higher than that achievable in the absence of the colloidal catalyst.

Advantageously, the use of colloidal catalyst in the method of the invention can ensure that CO₂ desorbs at a temperature that is below the boiling point of the aqueous colloidal solution. This is particularly beneficial for the large scale implementation of the method of the invention, which does not require installation of phase-change equipment. For example, thermal desorption of CO₂ may be effected at a temperature of about 100° C. or below. In some embodiments, thermal desorption of CO₂ is effected at a temperature of about 90° C. or below, about 80° C. or below, about 75° C. or below, about 60° C. or below, about 50° C. or below, or about 40° C. or below. For example, thermally desorbing CO₂ from the CO₂ absorbent having CO₂ absorbed thereto may be effected at a temperature of from about 40° C. to about 100° C., from about 50° C. to about 100° C., from about 60° C. to about 100° C., from about 70° C. to about 100° C., from about 80° C. to about 100° C., from about 80° C. to about 100° C., from about 80° C. to about 95° C., or from about 80° C. to about 90° C.

Accordingly, in some embodiments the step of thermally desorbing the CO₂ from the CO₂ absorbent is promoted by heating the aqueous colloidal solution to a temperature of about 90° C. or below, about 80° C. or below, about 75° C. or below, about 60° C. or below, about 50° C. or below, or about 40° C. or below. For example, the step of thermally desorbing the CO₂ from the CO₂ absorbent may be promoted by heating the aqueous colloidal solution to a temperature of from about 40° C. to about 100° C., from about 50° C. to about 100° C., from about 60° C. to about 100° C., from about 70° C. to about 100° C., from about 80° C. to about 100° C., from about 80° C. to about 100° C., from about 80° C. to about 95° C., or from about 80° C. to about 90° C.

Heating of the aqueous colloidal solution may be performed at any heating time conducive to at least a fraction of CO₂ desorbing from the CO₂-absorbant. For example, heating may be performed for at least about 1 minute. In some embodiments, heating is performed for at least about 5 minutes, at least about 10 minutes, at least about 15 minutes, at least about 20 minutes, at least about 25 minutes, at least about 30 minutes, at least about 45 minutes, at least about 60 minutes, or at least about 120 minutes.

Heating may be performed to desorb any amount of CO₂ from the CO₂-absorbent. For example, heating the aqueous colloidal solution may result in desorption of at least about 1% of CO₂ from the CO₂-absorbent. In some embodiments, heating the aqueous colloidal solution results in desorption of at least about 5% of CO₂, at least about 10% of CO₂, at least about 25% of CO₂, at least about 50% of CO₂, at least about 75% of CO₂, at least about 80% of CO₂, at least about 90% of CO₂, at least about 95% of CO₂, or at least about 99% of CO₂. In some embodiments, step b) affords desorption of at least about 50%, at least about 75%, at least about 80%, or at least about 90% of CO₂ from the CO₂ absorbent in about 30 minutes or less.

In some embodiments, the step of thermally desorbing the CO₂ from the CO₂ absorbent is promoted by (i) heating an aqueous solution comprising the CO₂ absorbent having CO₂ absorbed thereto at a temperature of about 90° C. or below, about 80° C. or below, about 75° C. or below, about 60° C. or below, about 50° C. or below, or about 40° C. or below, and (ii) introducing thereto the colloidal catalyst. For example, the step of thermally desorbing the CO₂ from the CO₂ absorbent may be promoted by (i) heating an aqueous solution comprising the CO₂ absorbent having CO₂ absorbed thereto to a temperature of from about 40° C. to about 100° C., from about 50° C. to about 100° C., from about 60° C. to about 100° C., from about 70° C. to about 100° C., from about 80° C. to about 100° C., from about 80° C. to about 100° C., from about 80° C. to about 95° C., or from about 80° C. to about 90° C., and (ii) introducing thereto the colloidal catalyst.

Certain embodiments of the invention will be now described by reference to the following non-limiting examples.

### EXAMPLES

### Example 1

### Materials

All amino acids, ferric ammonium citrate, 3-(n-morpholino) propanesulfonic acid (MOPS, >99.5%), 4-dorpholineethanesulfonic acid (MES, 99.5%), monoethanolamine (MEA, >99.5%), n-methyldiethanolamine (MDEA, >99.0%) and sulfanilic acid (99.0%) were reagent grade and purchased from Sigma-Aldrich.

Ethanol (>99.5%), acetone (>99.5%) and potassium hydroxide (KOH, >85.0%) were purchased from Chem-Supply, Australia.

1-ethyl-3-(3-dimethylaminopropyl) carbodiimide hydrochloride (EDC, 99%) and N-hydroxysuccinimide (NHS, 99%) were obtained from Proteochem, USA.

Ultra-pure nitrogen (N₂, 99.9%) and carbon dioxide (CO₂, 99.9%) were supplied by BOC Gases Australia and used for CO₂ absorption-desorption experiments.

Glycine (>98.5%), L-proline (Pro, 99.0%), sarcosine (Sarc, 98.0%), L-lysine hydrochloride (Lys, >98.0%) and L-arginine (Arg, >98.0%) were purchased from Sigma-Aldrich and used without further modification.

Isethionic acid sodium salt (98.0%) reagent grade was purchased from Sigma-Aldrich. D-glucose (>99.5%), tri-sodium citrate dihydrate (Na₃Cit, 99.0%), potassium hydroxide (KOH, >85.0%) and ethanol (>99.5%) were purchased from Chem-Supply, Australia.

### Characterization

Fourier-transform infrared (FTIR) spectra were measured using a Bruker Tensor II in 400-4000 cm-1 range. X-ray photoelectron spectroscopy (XPS) was conducted on a VG ESCALAB 220i-XL spectrometer with Al Kα radiation and 1486.6 eV photon energy. Thermogravimetric analysis (TGA) was performed on a NETZSCH TG 209 F1 Libra analyzer in 30-800° C. range with 10° C./min heating rate in N₂ atmosphere. Zeta potential was measured by a Malvern Zetasizer Nano ZS. Scanning electron microscopy (SEM) was performed on a FEI Teneo instrument with an operating voltage of 20 kV. Before taking SEM images, the materials were sputtered with 10 nm gold by a Quorum K575X ion sputter instrument with 30 mA current. Transmission electron microscopy (TEM), high-angle annular dark-field (HAADF) imaging, energy-dispersive X-ray spectroscopy (EDX) mapping and line spectra analysis were carried out on a JEOL 2100f instrument with a 200 kV acceleration voltage, equipped with oxford X-MaxN 80T detector and Gatan OneView 4k camera.

### Example 2

### CO₂ Absorption-Desorption Tests

CO₂ absorption and desorption experiments were conducted using an OptiMax™ workstation 1001 (Mettler-Toledo) connected to a dynamic gas flow apparatus. The device was equipped with a 1000 mL reactor, an adjustable mixer to keep the solution uniform, and a temperature controller system including a thermocouple and a heating jacket vessel to accurately control the reactor operating temperature and measure heat transfer parameters.

In a typical CO₂ absorption experiment, 500 mL of pre-prepared aqueous solution of CO₂-absorbent and 0.1 wt. % of colloidal nanocatalyst were mixed. The resulting colloidal solution was sonicated for 30 min at 60° C. and then transferred to the reactor.

To mimic the operating conditions of CO₂ absorption from post-combustion flue gas streams, the reactor temperature, pressure and rotation speed were set at 40° C., 40 kPag and 400 rpm, respectively. Then, a constant flow of a CO₂/N₂ binary mixture (635 mL/min, 10 vol. % CO₂ and 90 vol. % N₂) was bubbled into the aqueous solution containing the CO₂-absorbent. For this purpose, two separate gas flow controllers were utilized to provide constant CO₂ (Aalborg, CO₂-GFC17, 0-100 mL/min) and N₂ (Aalborg, N₂-GFC17, 0-10 L/min) streams. The treated gas stream was cooled using a Graham condenser connected to an external water circulator (−2±0.1° C.) and the evaporated solvent returned to the reactor. Then, it passed through two consecutive ice bath condensers (acetone-water mixture with −15±5° C.) to ensure any remaining moisture was trapped. The concentration of CO₂ and the volumetric flow rate of the treated gas stream were measured using an online CO₂ analyzer (BlueSens, BCP—CO₂) and a digital flow meter (Aalborg, GFM17, 0-1000 mL/min), respectively. During the CO₂ absorption, the concentration of CO₂ at the outlet stream was regularly monitored and the binary gas flow stopped bubbling when the concentration of CO₂ at outlet stream reached 15±0.1 vol. %.

For CO₂ desorption tests, N₂ gas was used as the carrier gas at a 90 mL/min flow rate. The CO₂ desorption process started by increasing the reactor temperature from 40 to 88° C., and then maintaining this temperature for 30 min and followed by finishing by returning the temperature to 40° C.

To quantitatively perform the heat flow calorimetry analysis and measure the amount of energy consumption during the catalyst-aided CO₂-desorption, the OptiMax™ workstation was connected to the OptiMax HFCal (Mettler-Toledo) probe. iControl software was used to directly record and evaluate all received information from OptiMax™ workstation and HFCal. Once the CO₂-desorption is completed, the reactor operating temperature was reduced to 40° C. and the N₂ inlet valve closed. The reactor was maintained at this temperature whilst samples were taken and the next CO₂ absorption-desorption cycle initiated.

### Relevant Calculations

To test the reliability of data measured by the online CO₂ analyzer, the CO₂ loading of the aqueous colloidal solution was also measured by a CO₂ Coulometer equipment (CM5015) with ±0.01 mol/L accuracy connected to an internal acidification module (CM5230). For each measurement, 2 mL CO₂-loaded aqueous colloidal solution was titrated using 1 mL concentrated H₂SO₄ to release absorbed CO₂. The comparative results of CO₂ loading using gas and liquid measurement techniques confirm the reliability of quantitative CO₂ absorption-desorption measurement technique used in the tests.

The flow rate of desorbed CO₂ was calculated using the following equation (Equation 1):

$${n}_{{CO}_{2}} = \frac{{X}_{{CO}_{2}}}{1 - {X}_{{CO}_{2}}} {n}_{{N}_{2}} \qquad Equation 1$$

where nCO₂ (mol/min) is the flow rate of CO₂ at outlet stream, nN₂ (mol/min) is the rate of N₂ at outlet stream and in the volume fraction of CO₂ in CO₂/N₂ binary mixture detected by the CO₂ analyzer.

The total amount of released CO₂ (N_{CO2}, mol) during CO₂ desorption (t, see) was calculated by the following equation (Equation 2):

$${N}_{{CO}_{2}} = {\int }_{0}^{t} {n}_{{CO}_{2}} dt \qquad Equation 2$$

The heat duty (HD, KJ/mol) of CO₂ desorption operation was calculated by the following equation (Equation 3):

$$HD = \frac{E}{{N}_{{CO}_{2}}} \qquad Equation 3$$

where E (kJ) is amount of consumed energy calculated according to the following equation (Equation 4):

$$E = {\int }_{0}^{t} HF dt \qquad Equation 4$$

where HF (kW) is the heat flow measured by HFCal probe.

To compare the efficiency of different heterogeneous catalysts, relative heat duty (RH, %) was calculated by the following equation (Equation 5):

$$R H = \frac{{HD}_{Cat}}{{HD}_{Blank}} \times 100 \qquad Equation 5$$

where HDCat (kJ) is the heat duty required for CO₂ desorption in the presence of catalyst and HDBlank (kJ) is the amount of required energy for the regeneration of the blank solution without any catalysts.

### Example 3

Preparation of Fe₃O₄@Aminoacid Colloidal Catalyst

For the synthesis of water-dispersible Fe₃O₄ colloidal catalyst cores, 20 mmol of ferric ammonium citrate and 150 mmol of amino acid (Alanine (Ala), Serine (Ser) and Glycine (Gly), Proline (Pro), Valine (Val), Histidine (His), Lysine (Lys), Arginine (Arg), Glutamine (Glu), Sarcosine (Sarc), Leucine (Leuc), Asparagine (Asp), or a mixture thereof) were dissolved in 100 mL water under vigorous stirring at room temperature. Then, the pH was raised to 11 by adding 10 M potassium hydroxide solution, changing the color from dark to reddish-brown. The solution was transferred to a stainless-steel autoclave and heated at 200° C. for 8 hr.

Afterwards, the autoclave was gradually cooled to room temperature and black solid precipitants were separated via the application of an external magnet. The obtained particulate material were repeatedly washed with acetone, ethanol and water to remove unreacted or physically attached molecules. During each washing step, the prepared products were suspended in the solvent, ultrasonicated for 30 min and separated by an external magnet.

Finally, the resultant materials were dried at 75° C. overnight under severe vacuum and labeled as Fe₃O₄—X, where X denotes the name of the amino acid. For instance, “Fe₃O₄-Ala” and “Fe₃O₄-His” represent the colloidal catalyst prepared with Fe₃O₄ core and Alanine and Histidine shell, respectively.

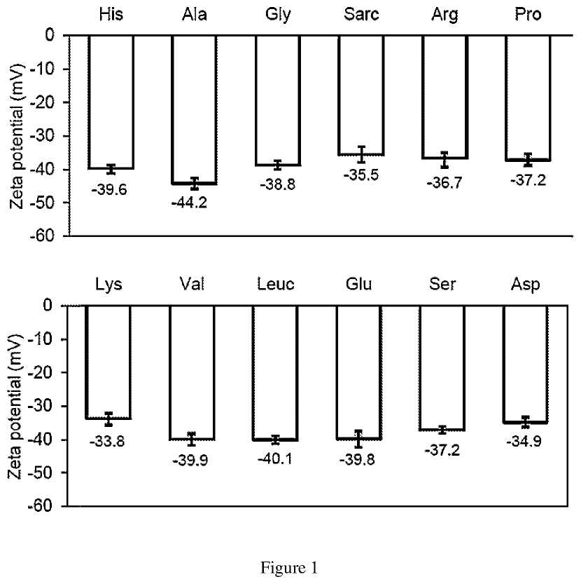

Zeta potential of Fe₃O₄@aminoacid colloidal catalyst measured in water at 25° C. and pH 9 for all tested amino acids is shown in FIG. 1.

### Example 4

Post-Functionalization of Fe₃O₄@Aminoacid Colloidal Catalyst

Fe₃O₄@aminoacid colloidal catalyst prepared in Example 3 was post-functionalised to introduce additional proton donor functional groups (e.g. —SO₃H). The pre-prepared colloidal catalyst were post-functionalized by the EDC-NHS cross-linking method in two steps.

First, the colloidal catalyst were functionalized by amine-reactive NHS molecules. Typically, 1 g of pre-prepared Fe₃O₄@aminoacid colloidal catalyst was first dispersed in MES buffer solution (500 mL, 0.1 M, pH 5.5) and sonicated for 30 min. After stirring for 4 hr at room temperature, EDC (1.6 g) and NHS (1.0 g) were added and the solution was stirred for 6 hr. The amine-reactive colloidal catalyst were subsequently separated using an external magnet and washed several times with water to remove unreacted EDC/NHS molecules.

The second step involved the surface functionalization using a molecule containing both amine (to react on the surface) and the targeted functional group (e.g. —SO₃H). Sulfanilic acid was chosen as the sample molecule for these tests. Briefly, EDC-NHS activated colloidal catalyst was subsequently redispersed in MOPS buffer (400 mL, 0.1 M, pH 7.5) and sonicated for 30 min. The cross-linking reaction started by introducing sulfanilic acid solution (100 mL, 1 M) and proceeded for 1 hr under continuous stirring. The resulting functionalised colloidal catalyst was separated, washed with water three times, and dried at 75° C. under vacuum overnight.

As the carboxyl functional group is the main source of Brønsted acid sites in Fe₃O₄-Ala colloidal catalyst, adding stronger Brønsted acid functional groups can markedly improve catalytic properties. To examine the role of sulfanilic acid during the synthesis of Fe₃O₄-Ala, a series of colloidal catalysts with different amino-to-sulfanilic acid ratios (i.e. 0.1:1 (A), 0.25:1 (B), 0.5:1 (C) and 0.75:1 (D)) were synthesized.

The effect of amino-to-sulfanilic acid ratio variation was investigated using XPS. Increasing the amino-to-sulfanilic acid ratio leads to an increase in the amount of sulfur on the surface of Fe₃O₄-Ala, changing from 0.36 at. % in Fe₃O₄-Ala-A to 3.83 at. % in Fe₃O₄-Ala-C. However, when the amino-to-sulfanilic acid ratio increased to 0.75:1 in Fe₃O₄-Ala-D, the amount of sulfur remarkably reduced to 0.46 at. %, indicating the competition between amino acid and sulfanilic acid. In the XPS high-resolution S2p spectrum of Fe₃O₄-Ala-C, the binding energies at 168.7 (i.e., S2p3/2) and 169.1 eV (i.e., S2p1/2) which were ascribed to S—OH and S═O, respectively, confirm the presence of —SO₃H group as the main source of sulfur on the surface of the catalyst. Notably, we could not observe any significant changes in the shape and size of engineered Fe₃O₄-Ala-A/D colloidal catalyst, revealing the negligible effect of amino-to-sulfanilic acid ratio on the morphology of the colloids.

FTIR spectroscopy of Fe₃O₄-Ala-S showed the appearance of S—O and S—O stretching in ˜1000-1200 cm⁻¹ range, while the vibrations associated with the carboxylic acid groups did not display a significant change compared to those of Fe₃O₄-Ala, confirming the successful sulfation of Fe₃O₄-Ala through a post surface functionalization method. The facile surface functionalization of Fe₃O₄-Ala in the aqueous medium provides further versatility for engineering its acidic characteristics using various other functional groups (e.g., —PO₃H and —SH).

### Example 5

### Chemical and Structural Characterisation

Fe₃O₄@aminoacid colloidal catalyst and functionalised Fe₃O₄@aminoacid colloidal catalyst obtained in Examples 3 and 4 were chemically and structurally characterised. The primary benefits of the synthesis methodology described in Examples 3 and 4 is that the colloidal catalyst can be obtained simply by a one-pot synthesis route in the aqueous solution.

Additionally, precursor compounds such as ferric ammonium citrate and amino acid are green, environment-friendly and low-cost chemicals, making the fabrication of the colloidal catalyst an affordable process and enabling its large-scale utilization in various industries. To examine the applicability of our synthesis methodology to various amino acids, a broad range of amino acids were used, as described in Example 3. The FTIR spectra of all prepared samples (not shown) were similar with three characteristic peaks. The sharp peak at ˜550 cm⁻¹ is associated with Fe—O vibration of the Fe₃O₄ core structure. Two peaks at ˜1340 and ˜1610 cm-1 are ascribed to the C═O and C—O stretching of the carboxylic acid group, coming from amino acid and trisodium citrate molecules. Furthermore, all sample colloidal catalysts have negative surface zeta potential, ranging from −33.8 (i.e. Fe₃O₄-Lys) to −44.2 mV (i.e. Fe₃O₄-Ala), indicating the accumulation of carboxylic acid groups on the exterior surface of Fe₃O₄ particles. Fe₃O₄-Ala exhibits the characteristic peaks of carboxylic acid at around ˜1340 and ˜1610 cm-1.

To quantitatively measure the amount of acidic-COOH functional groups, TGA was performed under N₂ flow and the weight reduction of samples between 250-600° C. was used as an indicator of acidic functional groups, including both carboxylic acids and hydroxyl groups. The results revealed that Fe₃O₄-Ala (2.4 wt. % reduction) had ˜70% more acidic functional groups than that conventional Fe₃O₄—COOH (1.4 wt. % reduction), i.e. having functional groups directly attached to the surface of the metal oxide core.

Scanning Electron Microscopy (SEM) and Transmission Electron Microscopy (TEM) images also show that Fe₃O₄-Ala has a regular morphology with small semi-cubic particles in the range of ˜5-20 nm (not shown). HAADF and EDX mapping results revealed the presence of Fe, O, C and N elements with homogeneous distribution through the Fe₃O₄-Ala structure.

The coating layer derived from carboxyl-containing shell molecules (i.e. trisodium citrate and amino acid) significantly enhances the hydrophilicity of the metal-oxide core, enabling the synthesized Fe₃O₄ to effectively be used for the preparation of aqueous colloidal solutions. The hydrophilicity of Fe₃O₄-Ala was evaluated by mixing its aqueous solution with various organic solvents, including ethyl acetate, cyclohexane, 1, 2-dichloroethane, and dichloromethane (DCM). After full dispersion into the binary solvents, Fe₃O₄-Ala colloidal catalyst accumulated in the aqueous phase after a short relaxation time in all studied mixtures. In addition to the hydrophilic nature of Fe₃O₄-Ala, the acidic aminoacid shell on the metal-oxide core endows the Fe₃O₄-Ala with excellent proton donation capability and catalytic properties for energy-efficient CO₂ capture.

### Example 6

Catalytic CO₂ Desorption Using Fe₃O₄@Aminoacids Colloidal Catalyst

To investigate the catalytic activity of the colloidal catalysts prepared in accordance to Examples 3 and 4, CO₂ desorption processes of (i) an aqueous CO₂-rich 5M MEA solution without no colloidal catalyst (blank), (ii) an aqueous CO₂-rich 5M MEA colloidal solution containing Fe₃O₄-Ala colloidal catalyst (benchmark) and (iii) an aqueous CO₂-rich 5M MEA colloidal solution containing various surface engineered Fe₃O₄ colloidal catalysts were compared.

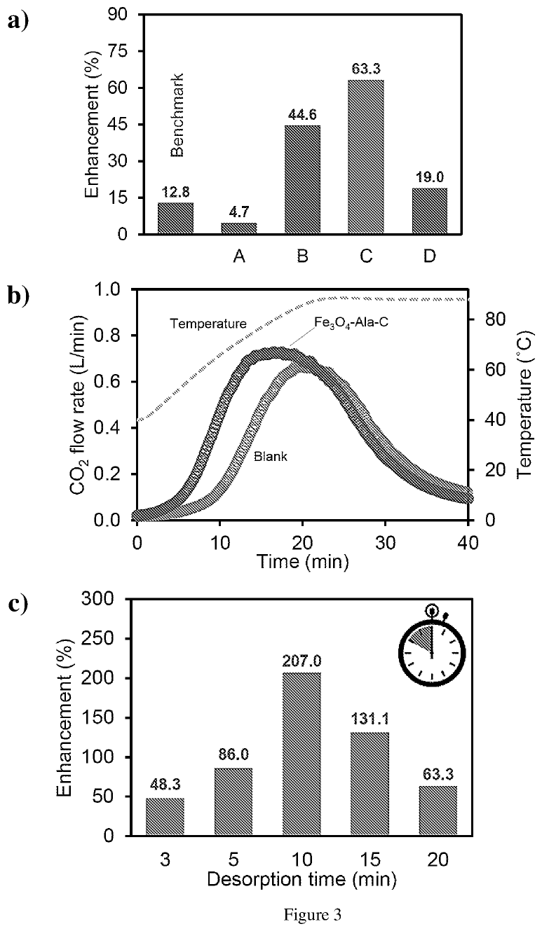

The concentration of colloidal catalyst was kept constant at 0.1 wt. % relative to the aqueous colloidal solution during all tests. As displayed in FIG. 3(a), all pre-prepared colloidal catalysts with different proton-donor (acidic) characteristics had a positive effect on the CO₂ desorption performance relative to the blank sample. Unmodified Fe₃O₄-Ala colloidal catalyst provided ˜12.8% increase in the total amount of desorbed CO₂ compared to the blank sample (without catalyst).

Except for Fe₃O₄-Ala-A with 4.7% enhancement in CO₂ desorption over the blank sample, all other samples of functionalised Fe₃O₄@aminoacid samples (B-D) exhibited a better CO₂ desorption performance than Fe₃O₄-Ala. Specifically, Fe₃O₄-Ala-C showed the best performance with 63.3% enhancement (over the blank sample) in the total desorbed CO₂, which is 4-fold higher than that of Fe₃O₄-Ala used as the benchmark. These findings are in line with the high density of sulfate functional groups on the surface of Fe₃O₄-Ala-C.

Next, a detailed comparison was performed between the CO₂ desorption behavior of CO₂-saturated 5M MEA aqueous solution with and without using Fe₃O₄-Ala-C throughout the regeneration process. As seen in FIG. 3(b), the presence of Fe₃O₄-Ala-C substantially facilitated CO₂ desorption from the initial moments of operation at 50° C. and increased with an increase in regeneration temperature. Although the maximum release of CO₂ in the blank aqueous solution was achieved at the maximum temperature of ˜88° C., the aqueous colloidal solution containing Fe₃O₄-Ala-C colloidal catalyst reached its maximum release at ˜75° C., resulted in shifting the CO₂ desorption peak from ˜20 to ˜16 min. Notably, the rate of CO₂ desorption started to decrease with a similar pattern in both cases when the regeneration temperature remained constant at 88° C., showing the superior performance of water-dispersible colloidal catalyst at low regeneration temperatures.

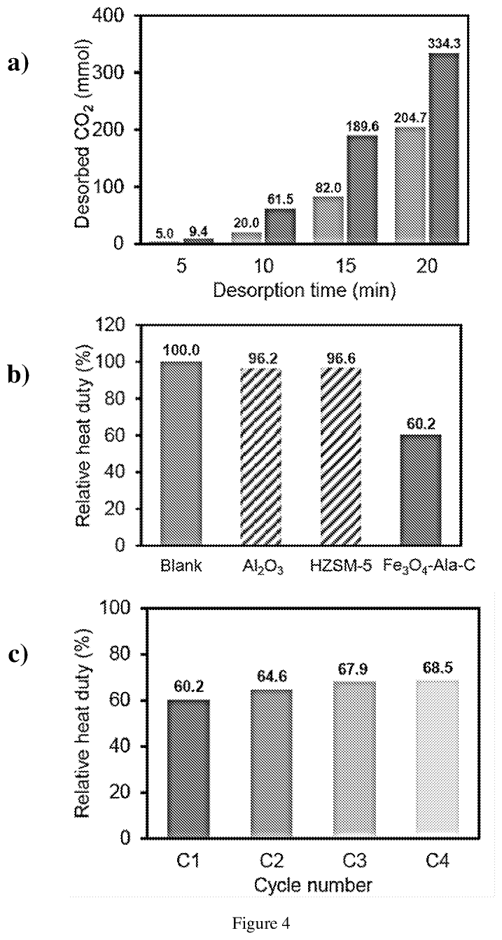

To further evaluate the effect of the colloidal catalyst, the CO₂ desorption enhancement achieved after adding Fe₃O₄-Ala-C was calculated at different time intervals, as shown in FIG. 3(c). It was found that the optimum catalytic activity was obtained after 10 min, which corresponds to 65° C. regeneration temperature, leading to ˜207% enhancement in the CO₂ desorption rate. This confirms the direct relationship between the operation temperature and the rate of CO₂ desorption during the first 20 min of operation until 65° C., and a reduction in catalytic activity at higher temperatures. The increase in the rate of CO₂ desorption can significantly increase the total amount of desorbed CO₂ molecules from the aqueous colloidal solution. For instance, the blank solution released ˜204.7 mmol CO₂ during ˜20 min desorption, whereas a higher value of 334.3 mmol was recorded at the same regeneration conditions (approximately 63% more) using a corresponding aqueous colloidal solution containing Fe₃O₄-Ala-C colloidal catalyst (FIG. 4(a)). This improvement in the CO₂ desorption can effectively compensate for the lower regeneration temperature at 88° C. compared to the conventional desorption temperature at 120-140° C.

The relative heat duty of CO₂-saturated aqueous 5M MEA colloidal solution containing Fe₃O₄-Ala-C colloidal catalyst was compared with those of typical heterogeneous solid acid catalysts (i.e. Al₂O₃ and HZSM-5), with data shown in FIG. 4(b). Both Al₂O₃ and HZSM-5 exhibited negligible relative heat duty reduction (˜3.4-3.8%) throughout CO₂ desorption from CO₂-rich MEA aqueous solution, owing to the very low concentration used (0.1 wt. %). A higher concentration of heterogeneous catalysts (e.g., 1.25 wt. % for Al₂O₃/HZSM-542 and 5 wt. % for montmorillonite) would be needed to effectively observe the catalytic activity of these conventional heterogeneous catalysts.

In contrast, the use of a same amount of Fe₃O₄-Ala-C colloidal catalyst (0.1 wt. %) exhibits a relative heat duty of 60.2%, which is ˜10-fold less than that observed for conventional heterogeneous solid acid catalysts at the same concentration. This is believe to be mainly due to the high accessibility of the colloidal catalyst dispersed throughout the aqueous solution, their fluidic behavior, and the unique decoration of proton-donor acidic functional groups. Importantly, the Fe₃O₄-Ala-C indicated good recyclability with only ˜8.3% decrease in the catalytic activity (relative heat duty increased from 60.2 to 68.5) during five consecutive CO₂ absorption-desorption cycles (FIG. 4(c)).

### Example 7

Catalysed CO₂ Desorption from Various CO₂ Absorbents

Amino acids have been identified as one of the green substitutes for alkanolamines as CO₂ absorbents, owing to the same amine functional group in their molecular structures. We therefore subsequently examined the catalytic performance of Fe₃O₄-Ala-C colloidal catalyst (i.e. Fe₃O₄@aminoacid-SO₃H) in a series of amino acid solutions, including long-chain (i.e., arginine and lysine), short-chain (i.e., glycine and sarcosine) and cyclic (i.e., histidine) amino acids.

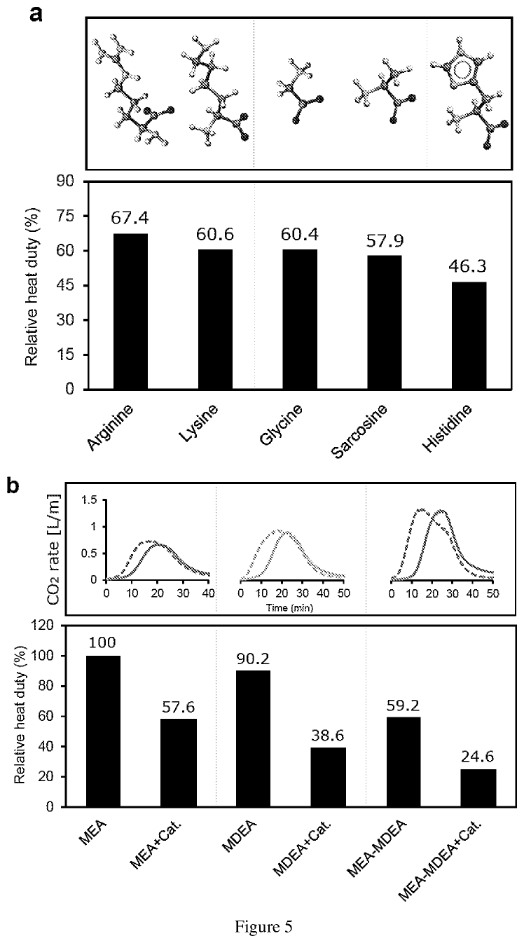

The Fe₃O₄-Ala-C colloidal catalyst successfully enhanced the rate of CO₂ desorption in all the aqueous amino acid colloidal solutions, depending on their physical-chemical properties, such as the number of amine functional groups, pKa values, molecular weight and water solubility. For example, Fe₃O₄-Ala-C displayed less catalytic activity in both arginine and lysine solutions, with 67.4% and 60.6% relative heat duty, respectively, than the similar amounts recorded for glycine (60.4%) and sarcosine (57.9%) solutions, as shown in FIG. 5(a). This could be attributed to the higher number of amino groups in long-chain amino acids (two or more per molecule) compared to the single amine functional group in the short-chain amino acids. It was also found that the histidine solution has the minimum relative heat duty of 46.3% in the presence of Fe₃O₄-Ala-C colloidal catalyst, which may be because of its phase-change behavior and crystal formation after CO₂ absorption.

CO₂-histidine complex, obtained by absorption of CO₂ to histidine, have a low solubility in aqueous solutions resulting in solid precipitation. The accumulation of CO₂-containing species in the solid phase could provide a better interaction between the colloidal catalyst and its targeted molecules.

The performance of Fe₃O₄-Ala-C colloidal catalyst was investigated in different aqueous amine colloidal solutions, including MEA (i.e., primary amine), MDEA (i.e., tertiary amine) and their mixtures (i.e., MEA-MDEA) as CO₂ absorbents.

The amount of required energy for the regeneration of MDEA without using colloidal catalyst was ˜10% less than that of MEA (FIG. 5(b)). After mixing MEA and MDEA, the relative heat duty of regeneration significantly reduced to 59.2%, which was much less than those of MEA (100%) and MDEA (90.2%), separately. This energy reduction with no catalyst provides a superior infrastructure to further decrease the required amount of energy using the proposed colloidal catalyst. As a result, MDEA and MEA-MDEA aqueous colloidal solutions were regenerated with only 38.6% and 24.6% relative heat duty, respectively, in the presence of 0.1 wt. % Fe₃O₄-Ala-C colloidal catalyst, while a substantial higher value of 57.6% was recorded for MEA in similar conditions. This observation could be justified by the synergetic effect between tertiary amines and acidic colloidal catalyst throughout the course of CO₂ desorption reactions.

### Example 8

Preparation of Fe₃O₄@MOF Colloidal Catalyst—Fe₃O₄—COOH Cores

Ferric ammonium citrate, containing both iron (Fe³⁺) and citric acid, was selected as a cheap and environmentally benign precursor for the initial fabrication of carboxylated Fe₃O₄ cores (Fe₃O₄—COOH). One of the benefits of the citrate assembly approach is that the carboxylate groups on the surface of the cores can serve as proton donor sites. Additionally, carboxylates can also provide stable hydrogen bonds to water molecules, allowing great dispersibility.

The surface modification is achieved via two steps by the assembly and adhesion of citrate ions to the Fe₃O₄ surface. Upon partial reduction of Fe³⁺ to Fe²⁺ in the non-aqueous solution and formation of single-crystal Fe₃O₄ nanoparticles, citrate ions easily attach on the surface owing to the strong coordination affinity between carboxylate groups and Fe³⁺/Fe²⁺ ions, resulting in aggregation of single nanoparticles to form large Fe₃O₄ nanoclusters.

Typically, ferric ammonium citrate (3.25 g) and NaOAc (6 g) were dissolved in 100 mL EG under vigorous stirring at room temperature. The formed hazy solution was transferred to a stainless-steel autoclave (150 mL capacity) and heated at 200° C. for 10 hr. Then, the autoclave was gradually cooled to room temperature and the black solid precipitants were separated via the application of an external magnet. The obtained nanoclusters were repeatedly washed with acetone, ethanol and water to remove unreacted or physically attached molecules. During each washing step, the nanoclusters were suspended in the solvent, ultrasonicated for 30 min and separated by an external magnet. Finally, the resultant materials were dried at 80° C. overnight under severe vacuum and labeled as Fe₃O₄—COOH.

Helium ion microscopy (HIM) and scanning electron microscopy (SEM) showed the spherical clusters ranging in size from ˜100 to 300 nm. Specifically, transmission electron microscopy (TEM) indicated the aggregated nanoclusters are composed of small adhesive Fe₃O₄ nanoparticles with about ˜2-5 nm size. High-angle annular dark-field (HAADF), energy-dispersive X-ray spectroscopy (EDX) mapping and elemental line scanning confirmed the homogeneous morphology of Fe₃O₄ nanoclusters with uniform Fe and O distribution throughout the structure. In addition, T2g and Eg peaks were identified as the prominent vibrational modes in the Raman spectrum which confirm the successful formation of Fe₃O₄ structure.

Different characterization methods were utilized to confirm the successful assembly of carboxylic acid groups (COOH) on the surface of Fe₃O₄—COOH cores. Fourier transform infrared spectroscopy (FTIR) displayed two characteristic peaks at ˜1340 and ˜1610 cm⁻¹ corresponding to the carbonyl group (C═O) and C—OH stretching of carboxylic acid group. X-ray photoelectron spectroscopy (XPS) revealed that the majority of Fe₃O₄—COOH surface is covered by C (˜59.5%) and O (˜33.9%), while the share of Fe was ˜6.6%. In contrast, elemental analysis showed the bulk is mainly composed of Fe (˜87.0%), which is ˜28-fold greater than that of C (˜2.9%) in the bulk sample, suggesting that COOH groups have mainly accumulated on the external surface of Fe₃O₄—COOH core.

The anchored citrate groups can subsequently favor the hydrophilic nature of Fe₃O₄—COOH, its electrostatic stabilization and dispersibility in the aqueous media, due to the intense negative charge density of surface.

Preparation of Fe₃O₄@MOF Colloidal Catalyst—Formation of MOF Shell

To appraise the modulated self-assembly of different MOFs on acidic Fe₃O₄—COOH substrate, seven MOFs, including ZIF-8, ZIF-67, MIL-100 (Fe), MOF-Fe(II), HKUST-1, UiO-66 and UiO-66-NH₂ with various metals (zinc (Zn), zirconium (Zr), cobalt (Co), copper (Cu), ferrous (Fe²⁺) and ferric (Fe³⁺)) and ligands (benzene-1,4-dicarboxylic acid (H2BDC), 2-aminoterephthalic acid (H2BDC-NH₂), 2,5-pyridinedicarboxylic acid (H2BDC-N), benzene-1,3,5-tricarboxylic acid (H3BTC) and 2-methylimidazole (2-Melm)) combinations were utilized. The successful preparation of Fe₃O₄@MOF core-shell structure was further confirmed by TEM images, coupled with FTIR, Raman spectroscopy, and XPS characterization.

Fe₃O₄@ZIF-8. For the synthesis of Fe₃O₄@ZIF-8 core-shell particles with a magnetic core, Fe₃O₄—COOH nanoclusters were first dispersed in 100 mL methanol (5 mg/mL) under vigorous stirring for 30 min. Then, 0.325 g of Zn(NO3)2·6H2O was added and the suspension was sonicated for 1 hr to facilitate zinc metal ion coordination on the carboxylate groups of the Fe₃O₄—COOH cluster surface. For the self-assembly of the ZIF-8 shell, 100 mL of 2-MeIm solution (2.82 mg/mL in methanol) was added dropwise to the suspension and the mixture was stirred at room temperature for 12 hr. The fabricated Fe₃O₄@ZIF-8 core-shell particles were separated by an external magnet. For the washing process, Fe₃O₄@ZIF-8 particles were sonicated in methanol for 15 min, while the solvent was replaced three times. The particles produced were vacuum dried at 120° C. overnight and labeled as Fe₃O₄@ZIF-8.

Fe₃O₄@ZIF-67. For the synthesis of Fe₃O₄@ZIF-67 core-shell particles with a magnetic core, Fe₃O₄—COOH nanoclusters were first dispersed in 100 mL methanol (50 mg/mL) under vigorous stirring for 30 min. Then, 0.5 g of Co(NO3)2·6H₂O was added and the suspension was sonicated for 1 hr to facilitate cobalt metal ion coordination on the carboxylate groups of the Fe₃O₄—COOH cluster surface. For the self-assembly of ZIF-67 shell, 100 mL of 2-MeIm solution (5.6 mg/mL in methanol) was added dropwise to the suspension and the mixture was stirred at room temperature for 24 hr. The fabricated Fe₃O₄@ZIF-67 core-shell particles were separated by an external magnet. For the washing process, Fe₃O₄@ZIF-67 particles were sonicated in methanol for 15 min, and the solvent was replaced three times. The particles were vacuum dried at 120° C. overnight and labeled as Fe₃O₄@ZIF-67.

Fe₃O₄@MIL-100 (Fe). For the synthesis of Fe₃O₄@MIL-100 (Fe) core-shell particles with a magnetic core, Fe₃O₄—COOH nanoclusters (5 mg/mL) were first dispersed in 100 mL of ethanol under vigorous stirring for 30 min. Then, 0.464 g of FeCl3·6H2O was added and the suspension was sonicated for 1 hr to facilitate iron metal ion coordination on the carboxylate groups of the Fe₃O₄—COOH cluster surface. The obtained suspension was transferred to a 250 mL round bottom flask and heated at 70° C. using an external oil bath with magnetic stirrer. After 1 hr, 100 mL of H₃BTC solution (3.61 mg/mL in water) was added dropwise to the suspension and the mixture stirred at 70° C. for a further 6 hr to homogencously grow the MIL-100 (Fe) shell. The fabricated Fe₃O₄@MIL-100 (Fe) core-shell particles were naturally cooled to room temperature and separated by an external magnet. For the washing process, Fe₃O₄@MIL-100 (Fe) particles were sonicated three times in ethanol for 15 min. The particles were vacuum dried at 110° C. overnight and labeled as Fe₃O₄@MIL-100 (Fc).

Fe₃O₄@MOF-Fe(II). For the synthesis of Fe₃O₄@MOF-Fe(II) core-shell particles with a magnetic core, Fe₃O₄—COOH nanoclusters were first dispersed in 50 mL water (10 mg/mL) under vigorous stirring for 30 min. Then, 0.278 g of FeSO4 was added and the suspension was sonicated for 1 hr to facilitate iron metal ion coordination on the carboxylate groups of the Fe₃O₄—COOH cluster surface. The obtained suspension was transferred to a 250 mL round bottom flask and heated at 130° C. using an external oil bath with magnetic stirrer. After 1 hr, 150 mL of H₂BDC-N solution (1.67 mg/mL in DMF) was added dropwise to the suspension and the mixture was stirred at 130° C. for further 4 hr to homogeneously grow the MOF-Fe(II) shell. The fabricated Fe₃O₄@MOF-Fe(II) core-shell particles were naturally cooled to room temperature and separated by an external magnet. For the washing process, Fe₃O₄@MOF-Fe(II) particles were sonicated three times in DMF, water and ethanol for 15 min. The particles were vacuum dried at 110° C. overnight and labeled as Fe₃O₄@MOF-Fe(II).

Fe₃O₄@HKUST-1. For the synthesis of Fe₃O₄@HKUST-1 core-shell particles with a magnetic core, Fe₃O₄—COOH nanoclusters were first dispersed in 100 mL of ethanol (5 mg/mL) under vigorous stirring for 30 min. Then, 0.343 g of Cu(NO3)2·3H2O was added and the suspension sonicated for 1 hr to facilitate copper metal ion coordination on the carboxylate groups of the Fe₃O₄—COOH cluster surface. The obtained solution was transferred to a 250 mL round bottom flask and heated at 85° C. using an external oil bath with magnetic stirrer. After 1 hr, 100 mL of H3BTC solution (3.61 mg/mL in ethanol) was added dropwise to the suspension and the mixture stirred at 85° C. for a further 24 hr to homogeneously grow the HKUST-1 shell.

The fabricated Fe₃O₄@HKUST-1 core-shell particles were naturally cooled to room temperature and separated by an external magnet. For the washing process, Fe₃O₄@HKUST-1 particles were sonicated three times in ethanol and dichloromethane for 15 min. The particles were vacuum dried at 120° C. overnight and labeled as Fe₃O₄@HKUST-1.

Fe₃O₄@UIO-66. For the synthesis of Fe₃O₄@UIO-66 core-shell particles with a magnetic core, Fe₃O₄—COOH nanoclusters were first dispersed in 100 mL of DMF (5 mg/mL) under vigorous stirring for 30 min. Then, 0.64 g of ZrCl4 was added and the suspension sonicated for 1 hr to facilitate zirconium metal ion coordination on the carboxylate groups of the Fe₃O₄—COOH cluster surface. The obtained solution was transferred to a 250 mL round bottom flask, mixed with 2 mL of AcOH and heated at 120° C. using an external oil bath with magnetic stirrer. After 1 hr, 100 mL of H₂BDC solution (4.56 mg/mL in DMF) was added dropwise to the suspension and the mixture was stirred at 120° C. for further 24 hr to homogeneously grow the UiO-66 shell. The fabricated Fe₃O₄@UiO-66 core-shell particles were naturally cooled to room temperature and separated by an external magnet. For the washing process, Fe₃O₄@UiO-66 particles were sonicated three times in hot DMF, water and ethanol for 15 min. The particles were vacuum dried at 110° C. overnight and labeled as Fe₃O₄@UIO-66.

Fe₃O₄@UIO-66-NH₂. For the synthesis of Fe₃O₄@UIO-66-NH₂ core-shell particles with a magnetic core, Fe₃O₄—COOH nanoclusters were first dispersed in 100 mL of DMF (5 mg/mL) under vigorous stirring for 30 min. Then, 0.64 g of ZrCl4 was added and the suspension sonicated for 1 hr to facilitate zirconium metal ion coordination on the carboxylate groups of the Fe₃O₄—COOH cluster surface. The obtained solution was transferred to a 250 mL round bottom flask, mixed with 2 mL of AcOH and heated at 120° C. using an external oil bath with magnetic stirrer. After 1 hr, 100 mL of H₂BDC solution (4.97 mg/mL in DMF) was added dropwise to the suspension and the mixture was stirred at 120° C. for further 24 hr to homogeneously grow the UiO-66-NH₂ shell. The fabricated Fe₃O₄@UIO-66-NH₂ core-shell particles were naturally cooled to room temperature and separated by an external magnet. For the washing process, Fe₃O₄@UIO-66-NH₂ particles were sonicated three times in hot DMF, water and ethanol for 15 min. The particles were vacuum dried at 110° C. overnight and labeled as Fe₃O₄@UIO-66-NH₂.

The porosity of Fe₃O₄@MOFs colloidal catalyst was investigated, particularly relative to those of pristine MOFs. The total pore volume of core-shell materials increased to ˜0.02-0.20 cm³/g, whereas a negligible porosity was detected for the core itself. The difference in the porosity of Fe₃O₄@MOFs can likely be attributed to the different pore architectures of MOFs on the exterior shell side. Notably, a comparison of pore volume exhibited that Fe₃O₄@UiO-66 has the maximum pore volume of ˜0.20 cm³/g among core-shell materials, highlighting the determining role of MOF type in the created porosity.

The mesoporosity, i.e., mesopore divided by total pore volume, of the modulated UiO-66 shell (˜85.4%) was much greater than that of pristine UiO-66 (˜11.1%) synthesized by the conventional procedure. The created mesoporosity in the coating could be ascribed to the induced missing-linker defects during the modulated self-assembly of MOFs on the acidic core. Similar to the carboxylic acid linkers used for the synthesis of MOFs, Fe₃O₄—COOH can partially play the role of ligand, change the bonding energy of metal-ligand coordination and manipulate the MOF formation mechanism. Accordingly, the MOF layers cannot smoothly grow on the carboxylic acid-rich substrate which can create mesoporosity and engineer the pore structure by hindering the bridging linkers and changing the coordination environment during their modulated self-assembly.

To confirm the role of missing-linker defects in the formation of engineered core-shell materials, thermogravimetric analysis (TGA) was used. Because of the thermal decomposition of organic ligands from 100 to 350° C., the weight reduction ratio of core-shell structure (ΔWC-S) to pristine MOF (ΔWP) in this temperature range was considered as an indicator of missing-linker deficiency.23 Although Zn-, Co- and Fe-based MOFs showed a high linker deficiency, the predominance of metal coordination through the network could have a negative impact on the self-assembly process, resulting in the poor formation of MOF structure. This is compatible with their low coating layer weights. In contrast, both Cu- and Zr-based MOFs displayed a good linker deficiency (˜56.2-91.5%), as well as high coating weight (˜30.1-34.7 wt. %) and homogenous coating, likely due to the optimum surface energy of Fe₃O₄—COOH@Cu and Fe₃O₄—COOH@Zr compared to their corresponding organic ligands.24, 25, 26 These results demonstrate that the self-assembly of MOFs on Fe₃O₄—COOH can be used as a simple platform to prepare advanced mesopore-induced core-shell materials with tailored properties, specifically more defects and unsaturated metal sites.

### Example 9

Preparation of Fe₃O₄@MOF-SO₄ Colloidal Catalyst

Fe₃O₄@MOFs obtained in accordance with the procedure described in Example 8 were treated with diluted sulfuric acid to introduce sulfate moieties through their defected structures. Fe₃O₄@MOF-SO₄ was prepared by dispersing Fe₃O₄@MOF colloidal catalysts into an aqueous solution of sulfuric acid (0.05 M, PH ˜1.3) at room conditions.

Typically, 1 g of Fe₃O₄@MOF was dispersed in 500 mL of 0.05 M aqueous H2SO4 solution. After sonicating for 15 min, the solution was gently stirred for 24 hr at room temperature. The nanocatalysts were washed three times to remove excess H₂SO₄ molecules. In each washing step, Fe₃O₄@MOF-SO₄ were magnetically separated, dispersed in 250 mL ultra-pure hot water (ca. 60° C.) and sonicated for 15 min, followed by magnetic separation and supernatant removal. Finally, the products were dried using a vacuum oven at 150° C. for 48 hr and stored for future use.

FTIR analysis of Fe₃O₄@MOF-SO₄ disclosed the presence of sulfur compounds in 800-1300 cm⁻¹ region, including both S—O (˜800-950 cm⁻¹) and S—O (˜1000-1300 cm⁻¹) bonds, thus confirming that-SO₄ species were successfully coordinated with active metal sites. In addition, elemental line scanning profiles also revealed that there is a good distribution of sulfur across the treated core-shells, while no sulfur was detected before acid treatment. Since the sulfates can take different coordination positions on the surface of uncoordinated metal clusters, missing-linker deficiency in defect-engineered core-shells can positively manipulate the chelating mode of sulfate by providing additional space, resulting in the improved sulfation yield.

To explore the versatility of aqueous sulfation method for Fe₃O₄@MOF, Fe₃O₄@HKUST-1. Fe₃O₄@UIO-66 and Fe₃O₄@UIO-66-NH₂ with the highest pore volumes were selected for post-treatment. TEM analysis illustrated the Fe₃O₄@MOF structures well preserved their core-shell structures at low pH values (i.e., ˜1.3), with a shell thickness changing from ˜10 nm in Fe₃O₄@HKUST-SO₄ to ˜40 nm in Fe₃O₄@UIO-66-NH₂—SO₄. HAADF and EDX maps reconfirmed the homogeneous distribution of metallic and organic elements corresponding to their MOF structures. Nevertheless, it was found that the amount of sulfur elements varies among Fe₃O₄@MOF-SO₄ materials and Fe₃O₄@HKUST-SO₄ possesses the least sulfur content when compared with those of Zr-based core-shell structures. This observation was further examined by high-resolution XPS analysis, showing the sulfur species on the exterior surface of Fe₃O₄@MOF-SO₄ materials. Notably, XPS peaks did not appear at 164-174 eV (typical range of binding energy for sulfur, S2p), validating the low sulfur signals in its EDX. Both Fe₃O₄@UIO-66-SO₄ and Fe₃O₄@UIO-66-NH₂—SO₄ exhibited that sulfate species were successfully coordinated to the Zr metals, owing to the tolerance of Zr—O bond in a broad pH range from 1 to 10.

### Example 10

Cyclic CO₂ Absorption-Desorption Using Fe₃O₄@MOF Colloidal Catalyst

Both CO₂ absorption and desorption experiments were conducted in an in-house modified OptiMax™ workstation 1001 (Mettler-Toledo) connected to a dynamic gas flow apparatus. The device was equipped with a 1000 mL reactor, an adjustable mixer to keep the solution uniform, and a temperature controller system including a thermocouple and a heating jacket vessel to accurately control the reactor operating temperature and measure heat transfer parameters.

In a typical CO₂ absorption experiment, 500 mL of pre-prepared aqueous 5M MEA solution (nearly equivalent to 30 wt. % MEA in water) and a desired amount of colloidal catalyst (varied from 0.01 to 0.1 wt. %) was mixed. No catalyst was added at this stage for the blank experiments. The prepared solution was sonicated for 30 min at 60° C. and then transferred to the reactor. To mimic the operating conditions of CO₂ absorption from post-combustion flue gas streams, the reactor temperature, pressure and rotation speed were set at 40° C., 40 kPa and 400 rpm, respectively. Then, a constant flow of a CO₂/N₂ binary mixture (635 mL/min, 15 vol. % CO₂ and 85 vol. % N₂) was bubbled into the solvent. For this purpose, two separate gas flow controllers were utilized to provide constant CO₂ (Aalborg, CO₂-GFC17, 0-100 mL/min) and N₂ (Aalborg, N₂-GFC17, 0-10 L/min) streams. The treated gas stream was cooled using a Graham condenser connected to an external water circulator (−2±0.1° C.) and the evaporated solvent returned to the reactor. Then, it passed through two consecutive ice bath condensers (acetone-water mixture with −15±5° C.) to ensure any remaining moisture was trapped. The concentration of CO₂ and the volumetric flow rate of the treated gas stream were measured using an online CO₂ analyzer (BlueSens, BCP—CO₂) and a digital flow meter (Aalborg, GFM17, 0-1000 mL/min), respectively. During the CO₂ absorption experiment, the concentration of CO₂ at the outlet stream was regularly monitored and the binary gas flow stopped bubbling when the concentration of CO₂ at outlet stream reached 15±0.1 vol. %.

For CO₂ desorption experiment, CO₂ gas flow stopped and N₂ gas flow continued as the carrier gas with 90 mL/min flow rate. The CO₂ desorption process started by increasing the reactor temperature from 40 to 88° C., maintained at this temperature for 30 min and finished by returning the temperature to 40° C. To quantitatively perform the heat flow calorimetry analysis and measure the amount of energy consumption during the catalyst-aided solvent regeneration, OptiMax™ workstation was connected to OptiMax HFCal (Mettler-Toledo) probe. iControl software was used to directly record and evaluate all received information from OptiMax™ workstation and HFCal. Once the solvent regeneration finished, the reactor operating temperature was reduced to 40° C. and the N₂ inlet valve closed. The reactor was maintained at this temperature for taking samples and initiating the next CO₂ absorption-desorption cycle.

### Example 11

Cyclic CO₂ Desorption Performance Using Fe₃O₄@MOF Colloidal Catalyst

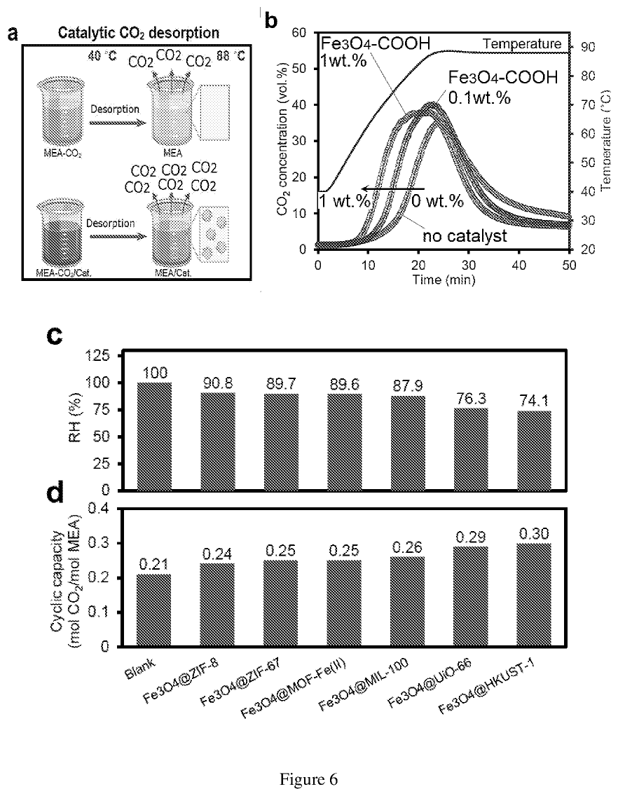

To illustrate that the prepared colloidal catalyst can be used to accelerate CO₂ desorption reactions, we first examined the catalytic performance of acidic Fe₃O₄—COOH cores for the regeneration (i.e. CO₂ desorption) of a CO₂-rich aqueous solution of monoethanolamine (MEA, 5M) at 88° C., as represented schematically in FIG. 6(a).

As shown in FIG. 6(b), adding a small amount of Fe₃O₄—COOH (0.1 wt. %) significantly increased the kinetics of CO₂ desorption, resulted in ˜27.3% less energy consumption, when compared with that of blank MEA solution (i.e. without any catalyst). By increasing the amount of Fe₃O₄—COOH from 0.1 to 1 wt. %, CO₂ released more quickly from the aqueous colloidal solution. However, the energy efficiency parameter (i.e. the absolute of relative heat duty reduction versus the amount of catalyst used) significantly dropped from 2.73 to 0.66, respectively. Thus, a concentration of 0.1 wt. % was established to be a good amount for the colloidal catalyst. The proposed amount is about 10 time smaller than previously reported values. This is due to the abundant active acidic sites on the surface of Fe₃O₄—COOH, as well as the Brownian motion and nanofluidic behavior of magnetic nanoclusters into the solvent.

The catalytic behavior of defect-engineered Fe₃O₄@MOF colloidal catalyst was also explored. FIGS. 6(c, d) show that all prepared core-shell colloidal catalysts improve the kinetics of CO₂ desorption, ranging from Fe₃O₄@ZIF-8 to Fe₃O₄@HKUST-1 with the least and the best performance, respectively.

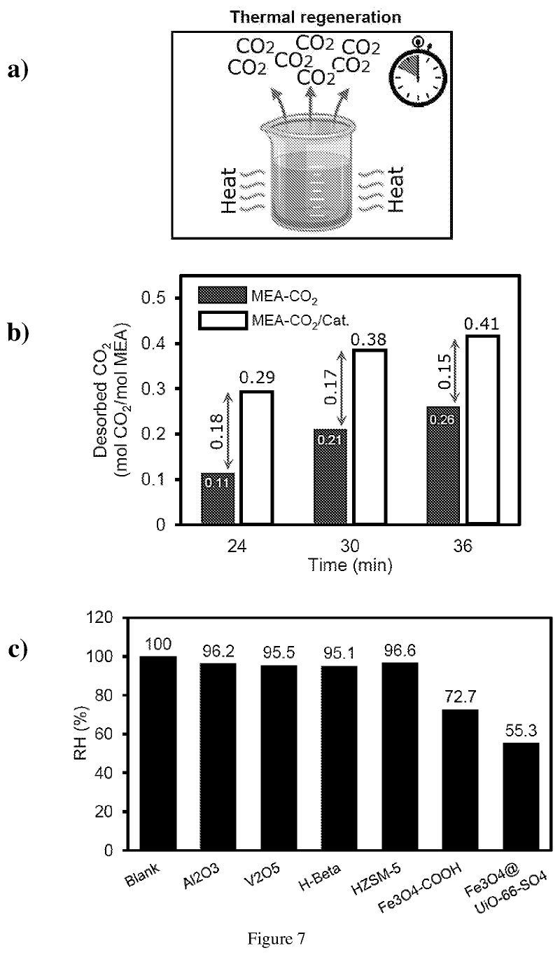

The enrichment of Brønsted acid sites through the hierarchical structure of core-shell structures (i.e. Fe₃O₄@MOF-SO₄) result in a distinct catalytic performance. The Fe₃O₄@UiO-66-SO₄ colloidal catalyst succeeded to desorb 80.9% more CO₂ compared with that of the blank solution at similar operating conditions. In addition, we found a decreasing trend in the differential desorbed CO₂ with the regeneration time (from 24 to 30 to 36 min), highlighting the substantial influence of the colloidal catalyst on the kinetics of CO₂ desorption, as shown in FIGS. 7(a, b).

To further investigate the catalytic performance of Fe₃O₄@UIO-66-SO₄ colloidal catalyst, its corresponding relative heat duty was compared with those of Fe₃O₄—COOH and commercialized solid acid catalysts, including conventional metal oxides (Al₂O₃, V2O5) and zeolites (H-Beta and HZSM-5), as shown in FIG. 6(c). Fe₃O₄@UIO-66-SO₄ colloidal catalyst exhibits the lowest required energy for the regeneration of CO₂-rich aqueous MEA colloidal solution with a relative heat duty of 55.3%. The catalytic performance of the tested conventional heterogeneous catalysts is not comparable with that of the colloidal catalyst of the kind described herein at low catalyst concentrations (less than 0.1 wt. %).

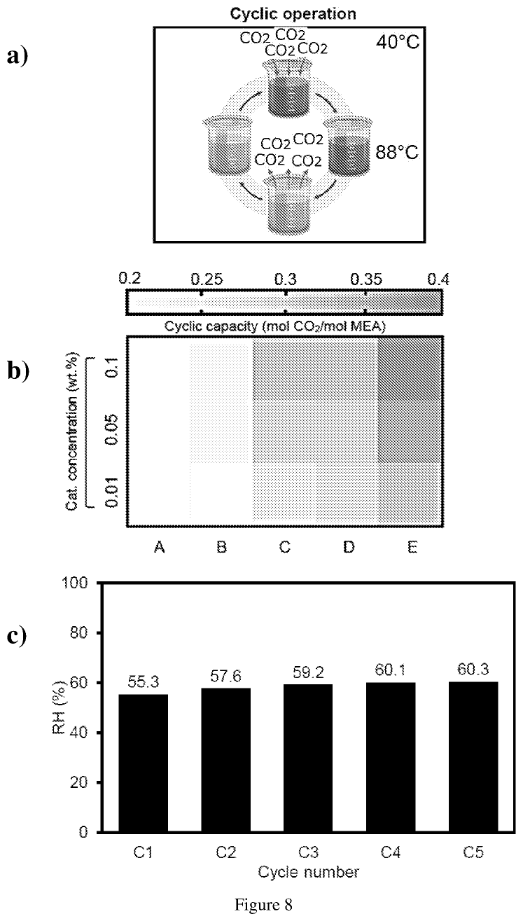

To specifically explore the performance of the tested catalysts at low concentrations (0.01, 0.05 and 0.1 wt. %), their cyclic CO₂ absorption-desorption capacity was also measured (see e.g. FIG. 8(a, b)). H-Beta zeolite failed to display any sensible promotion throughout the course of CO₂ desorption operation. Unlike H-Beta, all Fe₃O₄—COOH, Fe₃O₄@UIO-66 and Fe₃O₄@UiO-66-SO₄ demonstrated comparable cyclic CO₂ capacity, even at an extremely low concentration of 0.01 wt. %.

For instance, the use of Fe₃O₄@UIO-66-SO₄ colloidal catalyst in the aqueous colloidal solution increases the cyclic capacity of CO₂ absorption-desorption from 0.21 mol CO₂/mol MEA in the blank solution to 0.30, 0.33 and 0.38 mol CO₂/mol MEA with 0.01, 0.05 and 0.1 wt. % concentrations of colloidal catalyst, respectively, which are comparable with those of commercialized catalysts with ˜10- to ˜100-fold higher concentrations (˜1.0-1.1 wt. %). Since acidic catalyst allows for enhanced cumulative CO₂ desorption during CO₂ desorption, the solution can absorb more CO₂ in the subsequent absorption cycle, leading to the better performance of the aqueous solution (in terms of equilibrium and kinetics) in the absorption column. The stability of Fe₃O₄@UIO-66-SO₄ colloidal catalyst was assessed with five cycles of consecutive CO₂ absorption-desorption operation, with data shown in FIG. 8(c). Only ˜9% increase was recorded in the relative heat duty of MEA solution after five cycles with a stable condition throughout the last two cycles.

### Example 12

### Synthesis of Monodispersed Carbon Spheres (MCSs)

Monodispersed carbon spheres were synthesized using a hydrothermal method. Glucose (10 g) and tri-sodium citrate dihydrate (0.05 g) were dissolved in 100 mL Milli-Q water under vigorous stirring. The solution was then transferred to a stainless-steel autoclave and heated at 250° C. for 10 h. After natural cooling to room temperature, the solid precipitants of carbon were separated from the suspension by centrifugation (10,000 rpm, 30 min). The obtained carbon nanospheres were washed three times with Milli-Q water and ethanol to remove the impurities and unreacted components. The monodispersed carbon spheres were dried at 80° C. under the vacuum overnight and stored for future use.

For comparison, carbon spheres were synthesized without tri-sodium citrate dihydrate at 180° C. and labeled as conventional carbon spheres (CCS).

In the conventional synthesis procedure, carbon spheres are synthesized from glucose by a hydrothermal process at 180° C. The obtained carbon spheres from the conventional synthesis procedure in 180-250° C. range have all aggregated structures. Contrarily, adding a low concentration of Na₃Cit significantly improved the uniformity of carbon spheres and formed highly monodispersed particles. Na₃Cit exhibits a good performance as a new additive for the synthesis of MCS in a wide temperature range, the cross-linking of the glucose-based spheres remarkably reduced from 180 to 250° C. Therefore, we used 250° C. as a reference temperature for the synthesis of MCS.

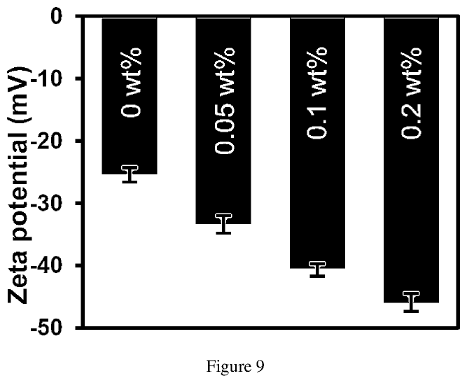

The citrate groups are highly prone to attach to the surface of the nanospheres rather than participating in the self-assembly process of glucose. This feature can be pointed out as the main reason for the formation of monodispersed carbon spheres in the aqueous solution. The attachment of citrate groups on the surface forms makes the nanospheres negatively charged and protects the spheres from aggregation by electrostatic repulsion. To further study the effect of citrate group on the surface charge in carbon nanospheres, a series of MCSs with different tri-sodium citrate concentrations were prepared. The measured zeta potential value showed that by increasing the amount of tri-sodium citrate dihydrate in the initial solution from 0.5 to 2.0 wt % the zeta potential gradually decreased from −33.3 to −46.0 mV, whereas the surface charge of CCS was less than all MCS materials, as shown in FIG. 9. It should be noted that no significant difference was observed in the surface charge of MCS materials when they were prepared at 180° C.

MCS was prepared using different concentrations of glucose and trisodium citrate dihydrate. The average particle size of MCS gradually increased from ˜100-150 nm in MCS-5-50 to ˜500-550 nm in MCS-20-50. Nevertheless, MCS maintained its uniformity even at a high glucose concentration which is a promising factor for its large-scale production and can substantially decrease the amount of solvent, the hydrothermal reactor and subsequently the capital cost of production. Contrarily, the proper formation of MCS completely depended on the concentration of trisodium citrate dihydrate in the initial aqueous solution. MCS with four different amounts of trisodium citrate dihydrate (0, 50, 100 and 200 mg) were synthesized. The MCS-5-0 without using any trisodium citrate dihydrate exhibited an aggregated structure composed of intra-connected carbon spheres with ˜150 nm average diameter. The introduction of only 50 mg trisodium citrate dihydrate had a remarkable impact on the monodispersity of the fabricated carbon spheres and resulted in the formation of MCS with a narrow particle size distribution in ˜200-300 nm range. In addition, a direct relationship was observed between the concentration of trisodium citrate dihydrate in the glucose solution and the average particle size of MCS achieved. As the amount of trisodium citrate dihydrate increased from 50 to 100 mg in the glucose solution, uniform MCS with ˜500-600 nm diameter was obtained. However, increasing the amount of trisodium citrate dihydrate to 200 mg substantially accelerated the cross-linking of carbon spheres and a wide range of particle size between 0.5 to 5.0 μm was obtained. These findings can highlight the importance of citrate concentration for the formation of uniform MCS with a proper particle size.

### Synthesis of Acidic Water-Dispersible Colloidal Catalysts (MCS-SO₃H)

The preparation of acidic water-dispersible colloidal catalysts was accomplished by treating the monodispersed carbon spheres with hot concentrated acid. Typically, pre-prepared carbon spheres were dispersed in concentrated H₂SO₄ and vigorously stirred for 30 min. The suspension was then ultrasonicated for 2 h to ensure complete dispersion of carbon nanospheres into the concentrated acid. The mixture was transferred to a stainless-steel autoclave and heated at 180° C. for 18 h. The obtained colloidal catalysts were separated by centrifugation (10,000 rpm, 30 min) and repeatedly washed with hot Milli-Q water (˜70-80° C.) to remove excess acids on the surface. The washing process was continued until the pH of the solution became neutral. The acidic water-dispersible colloidal catalysts were dried at 80° C. under the vacuum overnight and stored for future use.

MCS-SO₃H materials were synthesized by the conventional sulfation procedure using concentrated sulfuric acid at a high temperature. Due to the incomplete carbonization of glucose molecules at 250° C., only short-chain polymers with abundant aromatic compounds can be formed. Hence, the assembly of these complex aromatic polymers results in an amorphous structure in MCS which can easily bond to the sulfate groups in the liquid phase and form SO₃H-bearing MCS. As the spherical shape of nanoparticles plays a determining role in their nanofluidic efficiency to accelerate heat and mass transfer in the aqueous solution of amino acids, we carefully monitor the physical structure of MCS-SO₃H materials after acid treatment. The SEM image of MCS-SO₃H clearly shows that harsh sulfation conditions had no effect on the physical structure of MCS materials and they could preserve their integrity during the direct sulfation process.

### Preparation of Post-Functionalized Carbon Spheres (PF-MCS-SO₃H)

Post-functionalized carbon spheres were prepared by EDC-NHS cross-linking method. Typically, 1 g of pre-prepared monodispersed carbon spheres was dispersed in MES buffer solution (500 mL, 0.1 M, pH 5.5) and ultrasonicated for 1 h to ensure complete dispersion of nanomaterials into the solution. EDC (1.6 g) and NHS (1.0 g) were subsequently added to the solution and the reaction was stirred for 12 h in the absence of light. The amine-reactive carbon spheres were collected by centrifugation (10,000 rpm, 30 min) and washed three times with Milli-Q water to remove unreacted chemicals. The obtained carbon spheres were resuspended in MOPS buffer solution (400 mL, 0.5 M, pH 7.5). Then, 100 mL of sulfanilic acid solution (1 M, pH 7.5) was gradually added to the solution and stirred for 12 h under room conditions. The resulting post-functionalized carbon spheres were separated by centrifugation and dried at 80° C. under vacuum overnight and stored for future use.

MCSs are covered by a dense layer of citrate which creates a unique feature for post-functionalization. Here, sulfanilic acid was chosen as a favorable molecule with a benzene ring, one amino group (—NH₂) to connect to the carboxylic acid groups of MCS in the presence of EDC-NHS cross-linker and one sulfonic acid (—SO₃H) as the targeted molecule to the preparation of Brønsted acid colloidal catalyst. The successful coordination of sulfanilic acid molecules was confirmed by high-resolution S 2p spectra, showing the presence of 0.4 at % sulfur in sulfonic acid form on the surface of MCSs. High-angle annular dark-field (HAADF) and EDX mapping further revealed the homogeneous distribution of elements, especially oxygen and sulfur on the surface of MCS-SO₃H.

### Example 13

### Direct Air Capture (DAC) Experiments

For the preparation of potassium glycinate (GlyK), potassium sarcosinate (SarK), potassium argininate (ArgK) and potassium prolinate (ProK) solutions, each amino acid was dissolved in Milli-Q water with an equimolar amount of KOH. Only for potassium lysinate (LysK) solution, Lys was dissolved in Milli-Q water with two molar equivalents of KOH (one molar excess to neutralize HCl in lysine hydrochloride). The concentration of amino acid was kept constant at 1 M in all aqueous solutions.

In a typical CO₂ absorption process, a constant air flow was bubbled through the amino acid solution. To avoid water evaporation and subsequently concentration fluctuation during the CO₂ absorption process in amino acid solutions, a water-saturated air was used. The temperature of the water saturator and solvent container were both kept constant at 25° C. during the CO₂ absorption process. The CO₂ absorption continued for 10-30 days (depending on the volume of the solution and the air flow rate) to ensure a CO₂-saturated amino acid solution was achieved at ˜410 ppm CO₂ concentration.

For catalytic solvent regeneration experiments, a desired amount of colloidal catalyst was dispersed in 500 mL CO₂-saturated amino acid solution. To monitor the CO₂ desorption during solvent regeneration, the pre-prepared catalytic amino acid solution was placed in an in-house modified OptiMax™ workstation 1001 (Mettler-Toledo) with a 1000 mL reactor. The workstation was equipped with a temperature-controlling system and an adjustable mixture to accurately control the CO₂ desorption operation.

The solvent regeneration process was initiated by increasing the reactor temperature from 25 to 98° C. The temperature was maintained at 98° C. for 90 min before returning the operating temperature to 25° C. The desorbed CO₂ from the liquid surface was diluted using N₂ as a carrier gas (0.3 L/min) and passed through an online CO₂ analyzer (BlueSens, BCP—CO₂). To trap any remaining moisture, a Graham condenser (−2±0.1° C.) and two acetone-ice bath condensers (−15±5° C.) were utilized before the CO₂ detector.

The loading of rich and lean amino acid solutions before and after the solvent regeneration process was measured using a chitic module. The amount of CO₂ released at different time intervals throughout the solvent regeneration process was calculated using the following equations (Equations 1 and 2):

$${n}_{{CO}_{2}} = \frac{{X}_{{CO}_{2}}}{1 - {X}_{{CO}_{2}}} {n}_{{N}_{2}} \qquad ( 1 )$$

$${N}_{{CO}_{2}} = {\int }_{0}^{t} {n}_{{CO}_{2}} dt \qquad ( 2 )$$

where n_{N}_{₂} (mol/min) is the pure N₂ flow rate; X_{CO}_{₂} is the volume fraction of CO₂ in CO₂/N₂ binary mixture detected by the CO₂ analyzer; n_{CO}_{₂} (mol/min) is the flow rate of CO₂ at the outlet stream; t (min) is the duration of the solvent regeneration process; N_{CO}_{₂} is the total amount of CO₂ desorbed throughout the entire solvent regeneration process.

The Enhancement and Enhancement factor were calculated by the following equations (Equations 3 and 4):

$$Enhancement = \frac{{D}_{Cat} - {D}_{Blank}}{{D}_{Blank}} \times 100 \qquad ( 3 )$$

$$Enhancement factor = \frac{Enhancement}{{W}_{Cat}} \qquad ( 4 )$$

where D_{Cat} and D_{Blank} (mmol) are the total amount of CO₂ desorbed with and without using acidic colloidal catalyst, respectively, between 25-98° C.; W_{Cat} (wt %) is the concentration of acidic colloidal catalyst in the solution.

### Catalytic CO₂ Desorption in DAC Operation

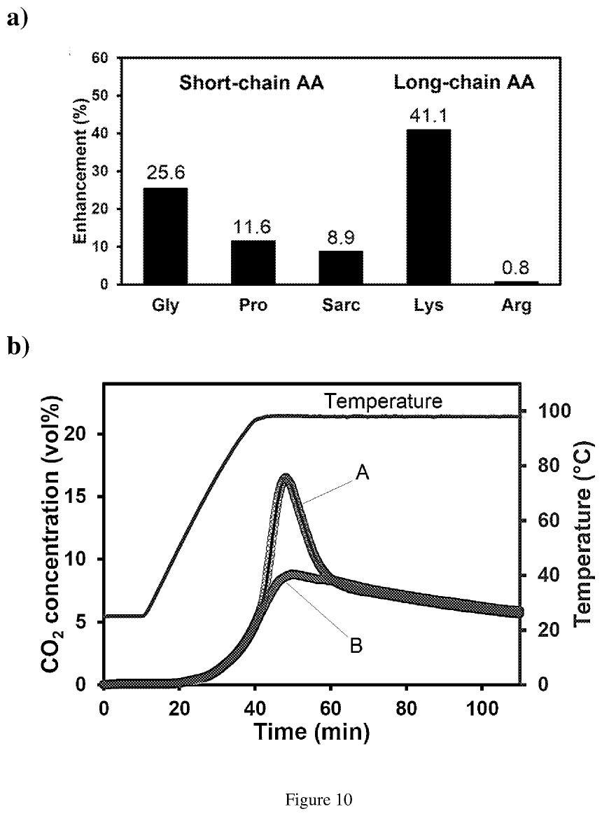

A low concentration of as-prepared MCS-SO₃H (0.2 wt %) was dispersed in a variety of amino acid solutions (1 M) saturated at ˜410 ppm CO₂ and their CO₂ desorption enhancement was measured at 98° C. As shown in FIG. 10(a), among short-chain amino acid solutions, glycine (GlyK) displayed the maximum CO₂ desorption enhancement of 25.6% which was much greater than those of proline (ProK, 11.6%) and sarcosine (SarcK, 8.9%). A larger difference was observed between the CO₂ desorption enhancement of long-chain amino acid solutions with more than one amine group. Lysine (LysK) recorded 41.1 CO₂ desorption enhancement in the presence of MCS-SO₃H colloidal catalyst.

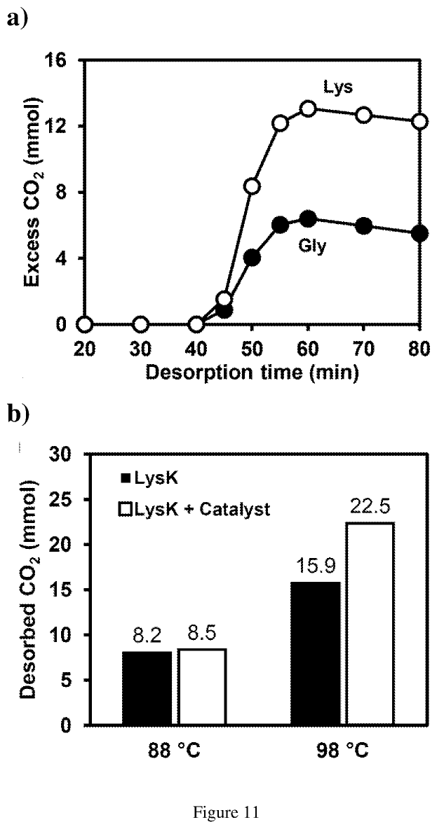

To further scrutinize the CO₂ desorption performance of lysine (LysK), its regeneration curve with and without using nanocatalyst was carefully monitored. As shown in FIG. 10(b), addition of a small amount of 0.1 wt % MCS-SO₃H (plot A) was successful to accelerate CO₂ desorption and released more CO₂ compared to that of the blank lysine solution without using any MCS-SO₃H (plot B). The majority of CO₂ desorption enhancement was taken place between 75-98° C., revealing the dependency of CO₂ desorption enhancement on the solvent regeneration duration. Thus, the effect of MCS-SO₃H on the excess release of CO₂ molecules was investigated at different time intervals for the best two amino acid solutions (lysine and glycine, FIG. 11(a)).

The results indicated that after 40 min, the excess amount of released CO₂ significantly increased until 60 min for both glycine (6.4 mmol) and lysine (13.1 mmol) and gradually decreased until the end of the desorption period, representing the poor catalytic activity over the long regeneration operations. Because the maximum CO₂ enhancement factor was taken place at the maximum temperature for both amino acid solutions, the effect of regeneration temperature on the performance of MCS-SO₃H was studied (FIG. 11(b)). The total amount of desorbed CO₂ is based on the thermodynamics of the system which means higher regeneration temperatures are in favor of reversing the carbamate breakdown reactions. Accordingly, the aqueous amino acid solution can desorb more CO₂ at 98° C. (15.9 mmol) compared to 88° C. (8.2 mmol), resulting in less CO₂ loading after the regeneration and more cyclic capacity.

Unlike different conventional CO₂ capture applications with a high CO₂ loading in the solution in which increasing the temperature in 70-98° C. range can suppress the performance of the catalyst, MCS-SO₃H exhibited a very low performance for the DAC solution at 88° C. Using 0.2 wt % MCS-SO₃H in LysK solution increased the CO₂ desorption from 8.2 to 8.5 mmol at 88° C., while using the same amount of catalyst resulted in an increase from 15.9 to 22.5 mmol at 98° C. This suggests that 88° C. is not enough to activate the nanocatalyst and a higher temperature should be chosen to regenerate amino acid solutions in the presence of nanocatalyst during the DAC operation.

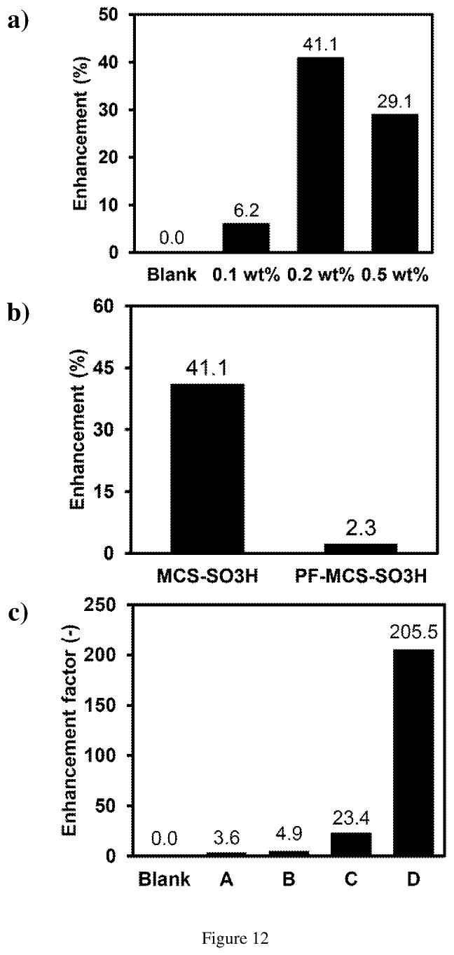

The amount of colloidal catalyst was also one of the determining factors during catalytic solvent regeneration (FIG. 12(a)). The results exhibits a performance of 6.2% for a very low concentration of MCS-SO₃H in potassium lysinate solution (LysK, 0.1 wt %). Increasing the amount of MCS-SO₃H from 0.1 to 0.2 wt % succeeded to release more CO₂ during the regeneration process. Further increasing the amount of catalyst decreased the CO₂ desorption enhancement from 41.1 to 29.1%. This may be linked to poor physical promotion effect of MCS-SO₃H nanocatalysts at high concentrations. Therefore, for the specific catalyst tested under these conditions 0.2 wt % can be a standard nanocatalyst concentration with a balance between the amount of nanocatalyst, CO₂ desorption enhancement and the catalyst efficiency for DAC operations. Notably, the optimum amount of MCS-SO₃H was five times less than those of heterogeneous acidic catalysts reported in the literature. This difference is believed to be primarily owing to the abundant sulfate groups on the exterior surface of MCS-SO₃H, along with its Brownian motion in the aqueous solution causing accelerated carbamate decomposition and easier mass transfer from the liquid to the gas phase.

The performance of PF-MCS-SO₃H in potassium lysinate solution (1 M) was also tested at 98° C. PF-MCS-SO₃H results in an enhancement value of 2.3% (FIG. 12(b)).

To further study the performance of MCS-SO₃H for CO₂ desorption in the DAC, the enhancement factor for the CO₂ desorption of MCS-SO₃H was compared to those of commercial heterogeneous solid acid catalysts, including montmorillonite, SO₄²⁻/ZrO₂/Al₂O₃ and SO₄²⁻/ZrO₂/SBA-15 (FIG. 12(c)). The concentration of material was kept constant at 1 wt % for all the heterogeneous catalysts and 0.2 wt % for MCS-SO₃H. SO₄²⁻/ZrO₂/SBA-15 showed the highest enhancement factor of 23.4 among all heterogeneous catalysts, followed by SO₄²⁻/ZrO₂/Al₂O₃ and montmorillonite with 4.9 and 3.9 enhancement factors, respectively. On the other hand, MCS-SO₃H recorded a super high enhancement factor of 205.5 which was ˜7.8 times greater than that of SO₄⁻²/ZrO₂/SBA-15 (as the representative of heterogeneous catalysts). This comparison clearly confirms the superiority of water-dispersible over heterogeneous colloidal catalyst.

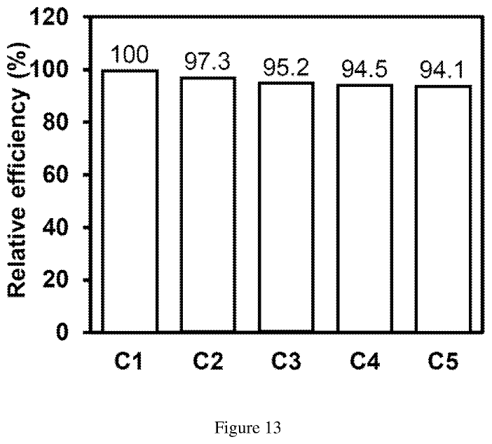

To verify the stability of MCS-SO₃H, its relative CO₂ desorption enhancement was measured for five consecutive cycles. As seen, MCS-SO₃H lost ˜2.7% of its activity during the first cycle and stabilized over five cycles, reaching 94.1% relative efficiency at the fifth cycle (FIG. 13, C1-C5 indicating each cycle). These observations can highlight the potential of MCS-SO₃H as a superior nanocatalyst with ease of use, high efficiency and good recyclability for energy-efficient CO₂ capture in DAC operations.

As used herein, the term “about”, in the context of numerical values, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of desorbing CO₂ from an aqueous liquid comprising CO₂, the method comprising the steps of:
a) providing said aqueous liquid in the form of an aqueous colloidal solution comprising (i) a CO₂ absorbent having CO₂ absorbed thereto and (ii) colloidal catalyst having a core-shell structure in which the shell comprises proton-donor groups, and
b) thermally desorbing CO₂ from the CO₂ absorbent, wherein the desorption is catalysed by the colloidal catalyst.

2. The method of claim 1, wherein the step of thermally desorbing CO₂ from the CO₂ absorbent is promoted by heating the aqueous colloidal solution.

3. The method of claim 1, wherein the step of thermally desorbing the CO₂ from the CO₂ absorbent is promoted by heating an aqueous solution comprising the CO₂ absorbent having CO₂ absorbed thereto, and introducing thereto the colloidal catalyst.

4. The method of claim 1 or 2, wherein providing said aqueous liquid comprises dispersing the colloidal catalyst into an aqueous solution of CO₂ absorbent having CO₂ absorbed thereto.

5. The method of any one of claims 1-4, wherein providing said aqueous liquid comprises contacting the CO₂ absorbent with a CO₂-containing fluid.

6. The method of claim 5, wherein the CO₂-containing fluid is flue gas, air, natural gas, a process stream containing methane or ethane, or a process stream generated during production of at least one of ammonia, cement, and fertilizer.

7. The method of any one of claims 1-6, wherein the proton-donor groups are selected from one or more of —PO₄, —SO₄, —SO₃H, —OH, —SH, —SO₂NH₂, —COOH, —PO₃H, —PO₃H₂, and —PO₃H⁻M⁺, where M⁺ is a metal cation.

8. The method of any one of claims 1-7, wherein the proton-donor groups comprise one or more super-acid group(s).

9. The method of any one of claims 1-8, wherein the colloidal catalyst has a core selected from a metal oxide, a liquid metal, a polymer, a carbon-based material, a nitride, a metal-organic framework (MOF), and a metal-phenolic network (MPN).

10. The method of any one of claims 1-9, wherein the shell of the colloidal catalyst is an amino acid shell, a metal-organic framework (MOF) shell, a metal-phenolic network (MPN) shell, a liquid metal shell, a polymer shell, a carbon-based shell, a carbon nitride shell, or a boron nitride shell.

11. The method of claim 10, wherein the shell of the colloidal catalyst is an amino acid shell comprising one or more of Alanine (Ala), Serine (Ser) and Glycine (Gly), Proline (Pro), Valine (Val), Histidine (His), Lysine (Lys), Arginine (Arg), Glutamine (Glu), Sarcosine (Sarc), Leucine (Leuc), and Asparagine (Asp).

12. The method of claim 10 or 11, wherein the amino acid shell is functionalised with one or more of —PO₄, —SO₄, —SO₃H, —OH, —SH, —SO₂NH₂, —COOH, —PO₃H, —PO₃H₂, —PO₃H⁻M⁺, where M⁺ is a metal cation.

13. The method of any one of claims 1-12, wherein the colloidal catalyst has a metal oxide core and a shell of one of amino-acids and MOF.

14. The method of any one of claims 9-13, wherein the MOF is selected from UiO-66, UiO-66-NH₂, ZIF-8, ZIF-67, MIL-100 (Fe), MOF-Fe(II), HKUST-1, and MIL-101 (Cr).

15. The method of any one of claims 1-14, wherein the shell provides up to 40% of the weight of the colloidal catalyst.

16. The method of any one of claims 1-15, wherein the colloidal catalyst is characterised by a negative surface zeta potential of about-30 mV or less, measured at 25° C. and a pH of 9.

17. The method of any one of claims 1-16, wherein the colloidal catalyst has a largest dimension of between about 0.1 nm and about 1,000 nm.

18. The method of any one of claims 1-17, wherein the CO₂-absorbent is selected from an amine, an amino acid, an ionic liquid, a carbonate, and a mixture thereof.

19. The method of claim 18, wherein the CO₂-absorbent is an amine selected from monoethanolamine (MEA), diglycolamine (DGA), diethanolamine (DEA), di-isopropanolamine (DIPA), triethanolamine (TEA), methyldiethanolamine (MDEA), 2-Amino-2-methylpropanol (AMP), benzylamine (BZA), piperazine (PZ), N,N-Diethyl-1,3-diaminopropane (DEAPA), beta-Diethylaminoethyl alcohol (DEEA), 1-Dimethylamino-2-propanol (1DMA2P), and 4-(diethylamine)-2-butanol (DEAB), and a combination thereof.

20. The method of any one of claims 1-19, wherein the colloidal solution comprises about 1 wt. % or less of the colloidal catalyst.

21. The method of any one of claims 1-20, wherein the colloidal solution comprises about 0.1 wt. % or less of the colloidal catalyst.

22. The method of any one of claims 1-21, wherein thermally desorbing CO₂ from the CO₂ absorbent having CO₂ absorbed thereto is effected at a temperature below 100° C.

23. The method of any one of claims 1-22, wherein thermally desorbing CO₂ from the CO₂ absorbent having CO₂ absorbed thereto is effected at a temperature of from about 40° C. to about 100° C.
